(19) United States
(12) Patent Application Publication
(10) Pub. No.: US 2012/0065384 A1
(43) Pub. Date: Mar. 15, 2012

(54) FLUORESCENT MRI PROBE

(75) Inventors: Tetsuo Nagano, Tokyo (JP); Kenjiro Hanaoka, Tokyo (JP); Takehiro Yamane, Tokyo (JP); Yasuaki Muramatsu, Tokyo (JP)

(73) Assignee: THE UNIVERSITY OF TOKYO, Tokyo (JP)

(21) Appl. No.: 13/254,523

(22) PCT Filed: Mar. 4, 2010
(86) PCT No.: PCT/JP2010/054069

§ 371 Date: Nov. 22, 2011

(30) Foreign Application Priority Data
Mar. 4, 2009 (JP) 2009-050203

(51) Int. Cl. C07F 5/00

(52) U.S. Cl. 534/16

(57) ABSTRACT

A fluorescent gadolinium complex compound comprising a residue of gadolinium.1,4,7,10-tetraazacyclododecane-N,N′,N″,N′″-tetraacetic acid or a residue of gadolinium.diethylenetriaminepentaacetic acid bound covalently with a group represented by the following general formula (I) (R¹ represents hydrogen atom or a substituent R², R⁴, R⁵ and R⁷ represent hydrogen atom, a halogen atom or a C₁₋₆ alkyl group, and R³ and R⁶ represent hydrogen atom, a halogen atom or a C₁₋₆ alkyl group), which is easily taken up into cells and useful as a probe observable by the fluorescence method and MRI.

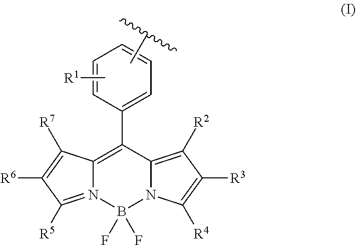

### TECHNICAL FIELD

The present invention relates to a fluorescent MRI probe which is easily taken up into cells and can be observed by the fluorescence method and the magnetic resonance imaging method.

### BACKGROUND ART

The magnetic resonance imaging (MRI) method has been widely used in the clinical field for diagnoses of various diseases as a method for noninvasively imaging deep parts of living bodies as tomographic images. As MRI contrast media, gadolinium complexes and iron oxide microparticles have been widely used, and in particular, use of gadolinium complexes can provide anatomical information with high resolution. However, since gadolinium complexes are metal ion complexes, they have high polarity and are hardly taken up into cells, and accordingly they have a drawback that it is difficult to measure cells or tissues by labeling with the complexes.

The fluorescence method utilizing a fluorescent reagent applying a fluorescent dye to a probe (fluorescent reagent) has an advantage that it enables convenient and highly sensitive measurement of a fluorescence reagent taken up into cells, in particular, it enables highly sensitive measurement of tissues and organs existing near body surfaces of living bodies by labeling with fluorescent reagent. However, this method has a drawback that it cannot detect and image fluorescence generated in a deep part of living body. From such points of view, visualization of the inside of living body by a combination of measurements by the MRI and fluorescence method has been focused. However, almost no practically useful fluorescent MRI probes having the dual characteristics, i.e., probes that can be used for both of the fluorescence method and the MEI method, have not yet been developed so far. In particular, no fluorescent MRI probe designed to be easily taken up into cells by combining a gadolinium complex and a fluorescent reagent has been known.

As attempts to introduce gadolinium complexes into cells, there have been reported several kinds of methods utilizing a cell-permeable peptide or cell-penetrating peptide (CPP) such as polyarginine and Tat peptide (Chem. Biol., 11, pp. 301-307, 2004; Contrast Media Mol. Imaging, 2, pp. 42-49, 2007). When a gadolinium complex is introduced into cells by any of these means utilizing CPP, MRI signals are enhanced. However, such methods for introducing a gadolinium complex into cells using CPP have a problem that amount of the complex introduced into cells easily changes depending on a condition under which the method is used, and the molecular weight of the gadolinium complex modified with CPP is rather large. Therefore, use of CPP for introducing a gadolinium complex into cells is not desirable.

Several kinds of compounds comprising a fluorescent dye and a gadolinium complex bound together have been reported. PTIR267 (Acad. Radiol., 11, pp. 1251-1259, 2004) is a compound formed by binding a gadolinium complex and a cyanine compound having an aliphatic chain, and has a property of being taken up into LDL. By using LDL labeled with PTIR267, PTIR267 can be incorporated into cells by endocytosis mediated by an LDL receptor. However, PTIR267 itself is not intracellularly taken up through penetration of cell membranes.

Gd(Rhoda-DOTA) (Bioconjugate Chem., 9, pp. 242-249, 1998) is a compound formed by binding a gadolinium complex and rhodamine, and use of this compound for in vivo imaging does not provide enhancement of MRI signals. According to researches by the inventors of the present invention, although this compound slightly migrates into cells, it does not have cell migration property in such a degree that MRI signals are enhanced. It is explained that this is because Gd(Rhoda-DOTA) is distributed in lipid tissues, and interactions with water molecules are decreased.

In order to solve this problem, a compound (GRID) comprising a gadolinium complex and rhodamine bound to dextran is also proposed. By injecting this GRID into a germ of a platanna (Xenopus laevis), differentiation pattern can be made observable by MRI and with fluorescence. Although it has been elucidated that GRID has cell migration property (NMR Biomed., 20, pp. 77-89, 2007), Gd(Rhoda-DOTA) itself is hardly taken up into cells. Therefore, it is considered that the cell migration property of GRID is attributable to the dextran moiety. Further, it has also been elucidated by an in vivo experiment that GRID localizes in lysosomes, and cannot exhibit sufficient ability as MRI contrast medium, and therefore, it is not desirable to use dextran for enhancing cell migration property of a complex consisting of a combination of a fluorescent dye and a gadolinium complex.

### PRIOR ART REFERENCES

### Non-Patent Documents

Non-patent document 1:Acad. Radiol., 11, pp. 1251-1259, 2004
Non-patent document 2: Bioconjugate Chem., 9, pp. 242-249, 1998
Non-patent document 3: NMR Biomed., 20, pp. 77-89, 2007

### SUMMARY OF THE INVENTION

### Object to be Achieved by the Invention

An object of the present invention is to provide a probe that is easily taken up into cells and observable by the fluorescence method and the MRI. More specifically, the object of the present invention is to provide a fluorescent MRI probe measurable by the fluorescence method and the MRI and having high cell migration property without using CPP, dextran or the like by combining a fluorescent dye and a gadolinium complex.

### Means for Achieving the Object

The inventors of the present invention conducted various researches to achieve the aforementioned object, and as a result, they found that a compound consisting of a gadolinium complex and a specific fluorescent dye bound to each other was easily taken up into cells and accumulated in the cells, and that the compound enabled highly sensitive imaging of a cell or tissue by both MRI and the fluorescence method. They also found that, by using this compound as a fluorescent MRI probe, detailed imaging was successfully achieved for a deep part of a living body by MRI, and a shallow part or a surface part of a living body by the fluorescence method. The present invention was accomplished on the basis of the aforementioned findings.

The present invention thus provides a fluorescent gadolinium complex compound comprising a residue of gadolinium.1,4,7,10-tetraazacyclododecane-N,N′,N″,N′″-tetraacetic acid (Gd-DOTA) which may have a substituent or a residue of gadolinium.diethylenetriaminepentaacetic acid (Gd-DTPA) which may have a substituent, wherein which residue is covalently bound with a group represented by the following general formula (I):

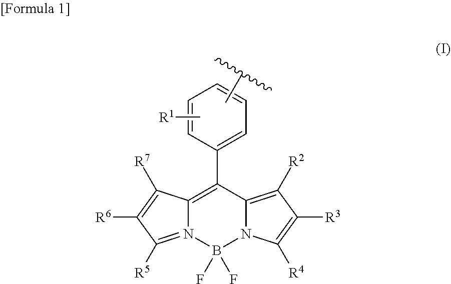

wherein R¹ represents hydrogen atom or 1 to 4 substituents existing at arbitrary positions on the benzene ring (when there are two or more substituents, they may be the same or different); R², R⁴, R⁵ and R⁷ independently represent hydrogen atom, a halogen atom or a C₁₋₆ alkyl group which may have a substituent, and R³ and R⁶ independently represent hydrogen atom, a halogen atom or a C₁₋₆ alkyl group which may have a substituent, or a group represented by the following general formula (II):

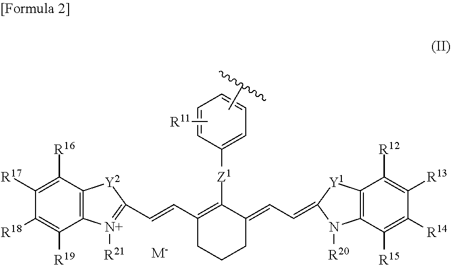

wherein R¹¹ represents hydrogen atom or 1 to 4 substituents existing at arbitrary positions on the benzene ring (when there are two or more substituents, they may be the same or different); R¹², R¹³, R¹⁴, R¹⁵, R¹⁶, R¹⁷, R¹⁸ and R¹⁹ independently represent hydrogen atom, a halogen atom or a C₁₋₆ alkyl group which may have a substituent; R²⁰ and R²¹ independently represent a C₁₋₁₈ alkyl group which may have a substituent; Z¹ represents oxygen atom, sulfur atom or —N(R²²)— (in the formula, R²² represents hydrogen atom or a C₁₋₆ alkyl group which may have a substituent); Y¹ and Y² independently represent —C(═O)—, —C(═S)— or —C(R²³)(R²⁴)— (in the formula, R²³ and R²⁴ independently represent a C₁₋₆ alkyl group which may have a substituent); and M⁻ represents a counter ion in a number required for neutralizing electrical charge.

According to a preferred embodiment of the aforementioned invention, there is provided the aforementioned fluorescent gadolinium complex compound, wherein the residue of gadolinium.1,4,7,10-tetraazacyclododecane-N,N′,N″,N′″-tetraacetic acid which may have a substituent or the residue of gadolinium.diethylenetriaminepentaacetic acid which may have a substituent is a residue of gadolinium.1,4,7,10-tetraazacyclododecane-N,N′,N″,N′″-tetraacetic acid having p-thioureidobenzyl group or an ester thereof or a residue of gadolinium.diethylenetriaminepentaacetic acid having p-thioureidobenzyl group or an ester thereof. According to a more preferred embodiment of the aforementioned invention, there is provided the aforementioned fluorescent gadolinium complex compound, wherein the residue of gadolinium.1,4,7,10-tetraazacyclododecane-N,N′,N″,N′″-tetraacetic acid which may have a substituent is a residue of gadolinium.1,4,7,10⁻tetraazacyclododecane-N,N′,N″,N′−-tetraacetic acid having p-thioureidobenzyl group.

According to another preferred embodiment of the aforementioned invention, there is provided the aforementioned fluorescent gadolinium complex compound, wherein a group represented by the aforementioned general formula (I) in which R¹ is hydrogen atom, R², R⁴, R⁵ and R⁷ are methyl groups, and R³ and R⁶ are hydrogen atoms, or a group represented by the aforementioned general formula (II) in which R¹¹ is hydrogen atom, R¹², R¹³, R¹⁴, R¹⁵, R¹⁶, R¹⁷, R¹⁸ and R¹⁹ are hydrogen atoms, R²⁰ and R²¹ are C₁₋₆ alkyl groups, Z¹ is oxygen atom, and Y¹ and Y² are —C(R²³)(R²⁴)— (in the R²³ and R²⁴ are independently C₁₋₆ alkyl groups) is bound via a covalent bond.

From other aspects of the present invention, there are provided a fluorescent MRI probe comprising the aforementioned fluorescent gadolinium complex compound as an active ingredient, and a fluorescent MRI contrast medium comprising the aforementioned fluorescent gadolinium complex compound as an active ingredient. The present invention also provides a method for imaging a living body, which comprises the step of administering the aforementioned fluorescent gadolinium complex compound to the living body, and performing imaging by the fluorescence method and/or MRI.

From still another aspect of the present invention, there is provided a fluorescent gadolinium ligand compound comprising a residue of 1,4,7,10-tetraazacyclododecane-N,N′,N″,N′″-tetraacetic acid (DOTA) which may have a substituent or a residue of diethylenetriaminepentaacetic acid (DTPA) which may have a substituent, wherein said residue is covalently bound with a group represented by the aforementioned general formula (I) or the aforementioned general formula (II).

### Effect of the Invention

Use of the fluorescent gadolinium complex compound of the present invention enables imaging of a living body by a combination of the fluorescence method and MRI. The fluorescent gadolinium complex compound of the present invention has a characteristic property that it is easily taken up into cells and accumulated in the cells, and enables imaging of a cell or tissue by the fluorescence method and/or MRI in a state that the compound is taken up into the cell or tissue. For example, the compound achieves imaging of a deep part of a living body by MRI, and imaging of a shallow part, a surface or a part near a surface of a living body by the fluorescence method. Accordingly, the compound can be preferably used in the clinical medical field, for example, for accurate diagnoses of various diseases.

### BRIEF DESCRIPTION OF THE DRAWINGS

FIG. 1 shows results of fluorescence imaging of the HeLa cells to which Gd-DOTA-BDP (Example 1) and Gd-DOTA-Cy (Example 2) are respectively introduced. The images on the left side are light microscopic images, and those on the right side are fluorescence microscopic images (lens: ×40, exposure time: 100 ms).

FIG. 2 shows results of fluorescence imaging of the HeLa cells to which Gd-DOTA-BDP (Example 1) and Gd-DOTA-Cy (Example 2) are respectively introduced. These images are confocal images ([Gd-DOTA-BDP] lens: ×60, filter: MBA, PMT: 475, gain: 1.2, [Gd-DOTA-Cy] lens: ×60, filter: Cy5, PMT: 800, gain: 3.0).

FIG. 3 shows results of measurement performed by MRI using Gd-DOTA-BDP (Example 1). In each photograph, a PBS buffer is shown on the left side, and the PBS buffer containing Gd-DOTA-BDP is shown on the right side. The image of “a” is an image under an ordinary light, the image of “b” is a fluorescence image, the image of “c” is an MR image (T1-weighted), and the image of “d” is an MR image (T2-weighted).

FIG. 4 shows MR images of the HeLa cells to which a probe is introduced. The image of “a” is an image under an ordinary light, and the image of “b” is an MR image (T1-weighted, T_{R}/T_{E}=600 ms/14 ms). Mag indicates the results obtained with the commercially available MRI contrast medium, Magnevist (registered trademark), BDP indicates the results obtained with Gd-DOTA-BDP (Example 1), and Cy indicates the results obtained with Gd-DOTA-Cy (Example 2).

FIG. 5 shows results of fluorescence imaging performed for a nude mouse to which Gd-DOTA-Cy (Example 2) was administered. The images of “a” are images of the Gd-DOTA-Cy-administered mouse, the images of “b” are images of a mouse to which Gd-DOTA-Cy was not administered, the images of “c” are images of the abdominal part, and the images of “d” are images of isolated organs.

FIG. 6 shows change of fluorescence intensity over time observed in fluorescence imaging performed for a nude mouse to which Gd⁻DOTA⁻Cy (Example 2) was administered.

FIG. 7 shows results of MRI performed for aortas of an arteriosclerosis model mouse, ApoE⁻/⁻mouse, and a wild-type mouse, to both of which Gd-DOTA-BDP (Example 1) was administered. The images of “a” show results for the ApoE⁻/⁻mouse, which is an arteriosclerosis model mouse, and the images of “b” show results for a wild-type mouse, including those obtained before the administration (left), after the administration (center), and after the additional administration (right).

FIG. 8 shows results of fluorescence imaging and Sudan IV staining performed for cut aortas isolated from an arteriosclerosis model mouse, ApoE⁻/⁻mouse, and a wild-type mouse, to which Gd-DOTA-BDP (Example 1) was administered. Among the images, the images of “a” on the upper part show the results for the arteriosclerosis model mouse, ApoE⁻/⁻mouse, and the images of “b” on the lower part show the results for the wild-type mouse. The fluorescence images are shown on the left side, and the Sudan IV staining images are shown on the right side.

FIG. 9 shows results of fluorescence imaging carried out with a fluorescence microscope and Oil Red 0 staining, performed for frozen sections of aortic parts of an arteriosclerosis model mouse, ApoE⁻/⁻mouse, and of a wild-type mouse, to both of which Gd-DOTA-BDP (Example 1) is administered, for which increase of MRI signals was observed, or change of signals was not observed. Among the images, the images of “a” on the upper part are the results for a frozen section of an aortic part for which increase of MRI signals was observed, and the images of “b” on the lower part are the results for a frozen section of an aortic part for which change of MRI signals was not observed. The fluorescence images are shown on the left side, and the Oil Red O staining images are shown on the right side.

FIG. 10 shows results of fluorescence imaging of the HeLa cell to which Gd-DOTA-PEG-Cy (Example 10) is introduced. A transmission image is shown on the left side, and a confocal fluorescence microscope image is shown on the right side.

FIG. 11 shows results of observation of kinetics of Gd-DOTA-PEG-Cy (Example 10) performed by fluorescence imaging for a nude mouse injected with Gd-DOTA-PEG-Cy from the caudal vein. Among the images, the images of “a” show the results of externally performed fluorescence imaging of the Gd-DOTA-PEG-Cy-administered mouse, and the images of “b” show the results of fluorescence imaging of organs isolated from the Gd-DOTA-PEG-Cy-administered mouse.

FIG. 12 shows results of MRI of the inside of a nude mouse injected with Gd-DOTA-PEG-Cy (Example 10) from the caudal vein. In the image, the MRI measurement result obtained before the administration of Gd-DOTA-PEG-Cy is shown on the left side, and the MRI measurement result obtained after the administration of Gd-DOTA-PEG-Cy is shown on the right side.

FIG. 13 shows results of fluorescence imaging performed with a confocal microscope for frozen sections prepared from the liver isolated from a nude mouse injected with Gd-DOTA-PEG-Cy (Example 10) from the orbital vein. A transmission image is shown on the left side, and a confocal fluorescence microscope image is shown on the right side.

### MODES FOR CARRYING OUT THE INVENTION

Both of gadolinium.1,4,7,10-tetraazacyclododecane-N,N′,N″,N′″-tetraacetic acid (Gd-DOTA) and gadolinium.diethylenetriaminepentaacetic acid (Gd-DTPA) are used as MRI contrast media, and are easily available. The fluorescent gadolinium complex compound of the present invention has a residue of DOTA or DTPA as a partial structure. The term “residue” used in this specification means a remaining structure obtained by removing one hydrogen atom from DOTA or DOTA having a substituent, or DTPA or DTPA having a substituent. This residue is directly bound to the benzene ring of the group represented by the general formula (I) or (II) at an arbitrary position.

The residue may be a residue of DOTA which has a substituent or DTPA which has a substituent. A residue obtained by removing one hydrogen atom in the substituent moiety can also be used. For example, it is also preferable to use a residue (—NH—CS—NH-DOTA or —NH—CS—NH-DTPA) obtained by removing hydrogen atom of the end amino group of thioureido group of DOTA having the thioureido group (NH₂—CS—NH-DOTA) or (of) DTPA having the thioureido group (NH₂—CS—NH-DTPA) (in the descriptions of these groups, DOTA and DTPA are indicated as a monovalent residue for convenience). Although the substitution position of the thioureido group is not particularly limited, the thioureido group preferably substitutes on one of the carbon atoms constituting the ring system of tetraazacyclododecane of DOTA, or on a carbon atom of the ethylene group of DTPA. As a substituent which can form the residue in such a manner, for example, hydroxyl group, amino group, carboxyl group, an alkyl group, an alkoxyl group, an alkoxycarbonyl group, an aralkyl group, an aryl group, a heteroaryl group, sulfo group, an alkylsulfonate group, ureido group, carbamoyl group, and the like can also be used, but the substituent is not limited to these examples.

In the general formula (I), R¹ represents hydrogen atom or 1 to 4 substituents existing at arbitrary positions on the benzene ring. When there are two or more substituents, they may be the same or different. Type of the substituent represented by R¹ is not particularly limited, and examples include a halogen atom (the halogen atom may be any of fluorine atom, chlorine atom, bromine atom, and iodine atom), hydroxyl group, an amino group (the amino group may be a mono-or di-substituted amino group), nitro group, carboxyl group, an alkyl group, an alkoxyl group, an alkoxycarbonyl group, an aralkyl group, an aryl group, a heteroaryl group, sulfo group, an alkylsulfonate group, and the like. It is preferred that R¹ is hydrogen atom, and it is also preferred that R¹ represents one alkyl group (for example, methyl group).

When R¹ represents 1 to 4 substituents existing at arbitrary positions on the benzene ring, one substituent among the 1 to 4 substituents may solely function or two or more substituents among them may cooperatively function as substituent(s) having an ability to interact with a target and thereby detect the target. Hereafter, such substituents may be generically referred to as “substituent for detection”.

The aforementioned target includes a target substance and a target environment. Examples of the target substance include reactive oxygen species, proton, and the like, and examples of the target environment include acidic environment, hypoxic environment, and the like.

Examples of one substituent having an ability to interact with the target and thereby detect the target by itself, among the 1 to 4 substituents, include a substituent which can solely interact with a target to cause a structural change such as modification and elimination and thereby make the target detectable. Examples of two or more substituents cooperatively interact with the target to have an ability of detecting the target, among the 1 to 4 substituents, include two or more substituents that bind together to form a ring structure and thereby make the target detectable. Examples also include two or more substituents already bound together to form a ring structure, which ring structure interacts with a target (including a case where a substituent on the ring structure participates in the interaction with the target) to cause a structural change and thereby make the target detectable.

The substituent for detection can be selected from
(1) a substituent
(a) that gives substantially high electron density to the benzene ring to which the substituent for detection binds so that the compound represented by the formula (I) is substantially non-fluorescent, before it interacts with the target, and
(b) that substantially reduces electron density of the benzene ring to which the substituent for detection binds so that the compound derived from the compound represented by the formula (I) via the interaction is substantially highly fluorescent, after it interacts with the target, and
(2) a substituent
(a) that gives substantially low electron density to the benzene ring to which the substituent for detection binds so that the compound represented by the formula (I) is substantially non-fluorescent, before it interacts with the target, and
(b) that substantially increases electron density of the benzene ring to which the substituent for detection binds so that the compound derived from the compound represented by the formula (I) via the interaction is substantially highly fluorescent, after it interacts with the target. By choosing the substituent for detection from such substituents, the so-called targeting function can be imparted to the compound of the general formula (I), i.e., it emits fluorescence only when it interacts with the target. So long as the aforementioned conditions (1) and (2) for the substituent for detection are satisfied, type of the substituent for detection is not particularly limited and can be appropriately chosen (as for the selection method of the substituent for detection, see, International Patent Publication WO2004/005917 and the like). Hereafter, several preferred substituents for detection are exemplified.

For the case where the target substance is nitrogen monoxide among reactive oxygen species;
R¹ is a combination of two amino groups (one of these amino groups may be a C₁₋₆ alkyl-substituted amino group substituted with one C₁₋₆ alkyl) substituting at adjacent positions on the benzene ring, and forming a triazole ring through an interaction with nitrogen monoxide (as for such substituents, see, Japanese Patent Laid-Open Publication (KOKAI) No. 10-226688 and the like).

For the case where the target substance is singlet oxygen among reactive oxygen species;
R¹ is a group represented by the following formula (A), in which two substituents substituting at adjacent positions on the benzene ring bind together to form a ring (in the formula, R³¹ and R³² independently represent a C₁₋₄ alkyl group or phenyl group) (as for this substituent, see, International Patent Publication WO99/51586 and the like).

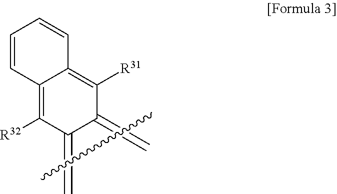

For the case where the target substance is hydrogen peroxide among reactive oxygen species;
R¹ is a group represented by the following formula (B) (as for this substituent, see, International Patent Application PCT/JP2009/054017 and the like).

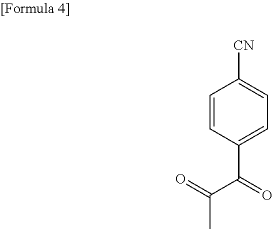

For the case where the target environment is an acidic environment; R¹ is an amino group which may be substituted with one or two alkyl groups (the alkyl groups may be substituted with a substituent other than amino group), such as unsubstituted amino group, dimethylamino group, diethylamino group, and N-ethyl-N-methylamino group (as for this substituent, see, International Patent Publication WO2008/059910 and the like).

For the case where the target environment is a hypoxic environment; R¹ is a group represented by any of the following formulas (C) to (G) (as for these substituents, see, Japanese Patent Application Nos. 2008-225389, 2008-129025, and the like).

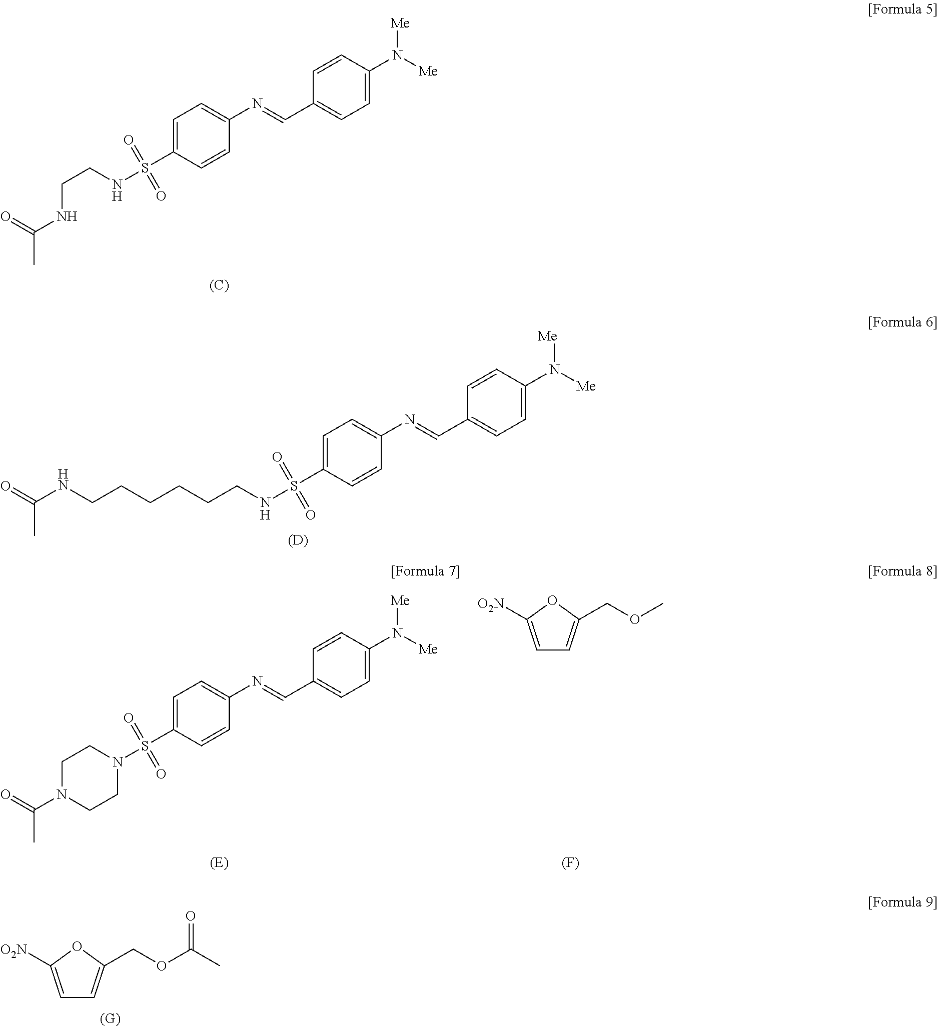

As the substituent for detection of the present invention, other than the examples mentioned above, there can also be appropriately chosen and used, for example, the substituents described in the catalogue of Molecular Probes (Handbook of Fluorescent Probes and Research Chemicals, Tenth edition, 2005), Chapter 2 (Thiol Reactive Probes), Chapter 20 (pH Indicators), and described in references concerning conventionally known fluorometry methods mentioned later, and the like.

R², R⁴, R⁵ and R⁷ independently represent hydrogen atom, a halogen atom or a C₁₋₆ alkyl group which may have a substituent, and R³ and R⁶ independently represent hydrogen atom, a halogen atom or a C₁₋₆ alkyl group which may have a substituent. In this specification, the alkyl group may be a linear, branched or cyclic alkyl group, or may be an alkyl group consisting of a combination of these, unless specifically indicated. The same shall apply to alkyl moieties of other substituents having an alkyl moiety (alkoxyl groups and the like). Further, in this specification, when the expression “which may have a substituent” is used for a certain functional group, type, number and substitution position of the substituent are not particularly limited, and the functional group may have, for example, a halogen atom (the halogen atom may be any of fluorine atom, chlorine atom, bromine atom, and iodine atom), hydroxyl group, an amino group (the amino group may be a mono- or di-substituted amino group), nitro group, carboxyl group, an alkyl group, an alkoxyl group, an alkoxycarbonyl group, an aralkyl group, an aryl group, a heteroaryl group, sulfo group, an alkylsulfonate group, ureido group, thioureido group, carbamoyl group, or the like as the substituent. It is preferred that R², R⁴, R⁵ and R⁷ are independently an unsubstituted C₁₋₆ alkyl group, and it is more preferred that R², R⁴, R⁵ and R⁷ are methyl groups. It is preferred that R³ and R⁶ are independently hydrogen atom, a carboxy-substituted C₁₋₆ alkyl group, or a C₁₋₆ alkoxy-substituted C₁₋₆ alkyl group, and it is more preferred that they are hydrogen atoms.

In addition, combination of R² to R⁷ preferred for each type of the substituents for detection mentioned above can be appropriately chosen by referring to the references, and the like, mentioned in the explanations of each of the substituents for detection. For example, when R¹ is an amino group which may be substituted with one or two alkyl groups (the alkyl groups may be substituted with substituents other than amino group), by which the substituent for detection is exemplified for the case where the target environment is an acidic environment, it is preferred that R³ and R⁶ are independently a monocarboxy(C₁₋₄ alkyl) group among C₁₋₆ alkyl groups which may have a substituent. It should be noted that those skilled in the art can also understand preferred combinations of R¹ and, R³ and R⁶ by referring to International Patent Publication WO2008/059910 and the like.

In the compound of the general formula (I), one or more of the fluorine atoms binding to the boron atom existing in the indacene structure may be replaced with C₁₋₆ alkoxyl groups which may have a substituent or aryloxy groups which may have a substituent. By replacing one or more of the fluorine atoms binding to the boron atom with C₁₋₆ alkoxyl groups which may have a substituent or aryloxy groups which may have a substituent, and introducing the substituent for detection described above into the C₁₋₆ alkoxyl groups which may have a substituent or aryloxy groups which may have a substituent, the so-called targeting function can be imparted to the compound which can be made to emit fluorescence only when it interacts with the target.

As the substituent for detection for such a case, there can be selected a substituent
(a) that is quenched by the mechanism of the photo-induced electron transfer (PeT) from the indacene structure as the fluorescent mother nucleus to the substituent for detection, or from the substituent for detection to the indacene structure, before it interacts with a target,
(b) in which the quenching caused by the PeT mechanism from the indacene structure as the fluorescent mother nucleus to the substituent for detection, or from the substituent for detection to the indacene structure is substantially cancelled, after it interacts with the target.

In the general formula (II), R¹¹ represents hydrogen atom or 1 to 4 substituents existing at arbitrary positions on the benzene ring. When there are two or more substituents, they may be the same or different. Type of the substituent represented by R¹¹ is not particularly limited, and examples include a halogen atom (the halogen atom may be any of fluorine atom, chlorine atom, bromine atom, and iodine atom), hydroxyl group, an amino group (the amino group may be a mono- or di-substituted amino group), nitro group, carboxyl group, an alkyl group, an alkoxyl group, an alkoxycarbonyl group, an aralkyl group, an aryl group, a heteroaryl group, sulfo group, an alkylsulfonate group, and the like. It is preferred that R¹¹ is hydrogen atom, and it is also preferred that R¹¹ represents one alkyl group (for example, methyl group).

When R¹¹ represents 1 to 4 substituents existing at arbitrary positions on the benzene ring, one substituent among the 1 to 4 substituents may solely function or two or more substituents among them cooperatively function as substituent(s) having an ability to interact with a target and thereby detect the target (substituent for detection). Preferred embodiments of R¹¹ as the substituent for detection are similar to those mentioned in the aforementioned descriptions concerning R¹ of the compound of the general formula (I).

R¹², R¹³, R¹⁴, R¹⁵, R¹⁶, R¹⁷, R¹⁸ and R¹⁹ independently represent hydrogen atom, a halogen atom or a C₁₋₆ alkyl group which may have a substituent. It is preferred that R¹², R¹³, R¹⁴, R¹⁵, R¹⁶, R¹⁷, R¹⁸ and R¹⁹ independently represent hydrogen atom, a halogen atom or an unsubstituted C₁₋₆ alkyl group, and it is more preferred that R¹², R¹³, R¹⁴, R¹⁵, R¹⁶, R¹⁷, R¹⁸ and R¹⁹ are hydrogen atoms. R²⁰ and R²¹ independently represent a C₁₋₁₈ alkyl group which may have a substituent. It is preferred that they independently represent a C₁₋₆ alkyl group which may have a substituent, and it is more preferred that they independently represent an unsubstituted C₁₋₆ alkyl group. For example, ethyl group, n-propyl group, n-butyl group, and the like are preferably used.

Z¹ represents oxygen atom, sulfur atom or —N(R²²)— (in the formula, R²² represents hydrogen atom or a C₁₋₆ alkyl group which may have a substituent), and it preferably represents oxygen atom. Y¹ and Y² independently represent —C(═O)—, —C(═S)— or —C(R²³)(R²⁴)— (in the formula, R²³ and R²⁴ independently represent a C₁₋₆ alkyl group which may have a substituent), and they preferably represent —C(R²³)(R²⁴)—. As R²³ and R²⁴, an unsubstituted C₁₋₆ alkyl group is preferred, and for example, it is preferred that both R²³ and R²⁴ are methyl groups. M⁻ represents a counter ion in a number required for neutralizing electrical charge. However, the charge is usually neutralized by the carboxylate anions existing in the residue of Gd-DOTA or Gd-DTPA, and accordingly, M⁻ may not exist. When M⁻ exists, iodine ion, chlorine ion, and the like can be used.

In general, the fluorescent gadolinium complex compound of the present invention can be easily prepared by reacting a compound having a group represented by the aforementioned general formula (I) or (II), which is bound with a reactive functional group for introducing a reactive DOTA derivative or a reactive DTPA derivative at an arbitrary position on the benzene ring such as amino group, hydroxyl group, carboxyl group, thiol group, isocyanato group, and isothiocyanato group, with a reactive DOTA derivative or a reactive DTPA derivative to prepare a fluorescent gadolinium ligand compound, and then reacting a gadolinium salt with the ligand compound. The aforementioned fluorescent gadolinium ligand compound used as a preparation intermediate is also a compound falling within the scope of the present invention.

For example, when a compound bound with isothiocyanato group for introducing a reactive DOTA derivative or a reactive DTPA derivative on the benzene ring in the group represented by the aforementioned general formula (I) or (II) is used for the preparation of the fluorescent gadolinium ligand compound of the present invention, a compound having amino group, for example, DOTA having p-aminobenzyl group as a substituent, or DTPA having p-aminobenzyl group as a substituent, may be reacted as the reactive DOTA derivative or the reactive DTPA derivative. For example, as DOTA or DTPA having p-aminobenzyl group, the following compounds are marketed (Macrocyclics: http://www.macrocyclics.com), and these reactive DOTA derivative and reactive DTPA derivatives can be preferably used.

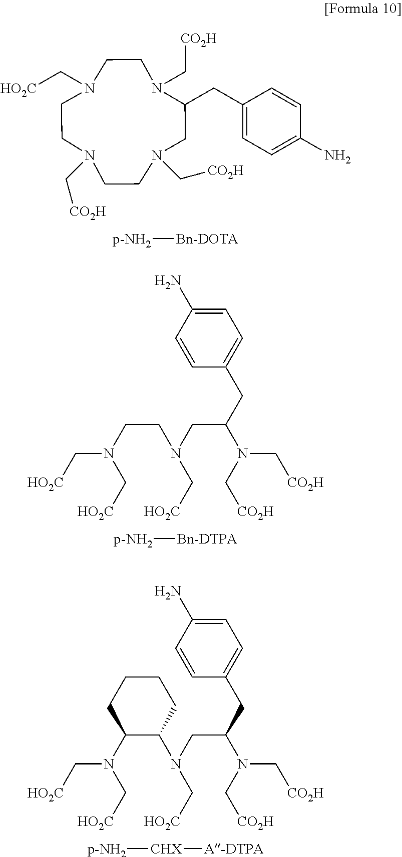

Further, when a compound having amino group for introducing a reactive DOTA derivative or a reactive DTPA derivative on the benzene ring in the group represented by the aforementioned general formula (I) or (II) is used, a compound having carboxyl group or isothiocyanato group, etc., for example, DOTA or DTPA having p-isothiocyanatobenzyl group as a substituent, or a compound having carboxyl group activated with succinimidyl group or p-nitrophenyloxy group, for example, DOTA or DTPA having succinimidyloxycarbonylmethyl group as a substituent, DTPA anhydride which is acid anhydride of DTPA, and the like can be used as the reactive DOTA derivative or reactive DTPA derivative. For example, the following commercially available compounds can be used, however, the compounds as mentioned above are not limited to these examples.

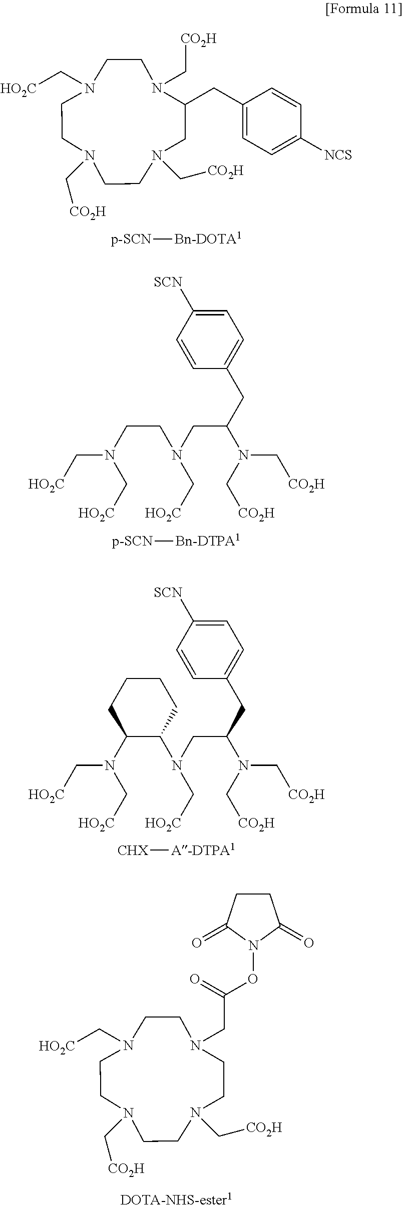

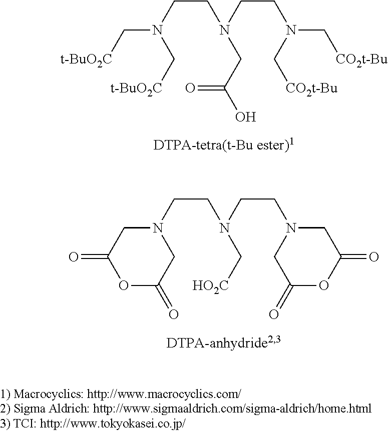

The reaction of the fluorescent gadolinium ligand compound and a gadolinium salt can be carried out by a method well known to those skilled in the art. As the gadolinium salt, for example, GdCl₃.6H₂O and the like can be used, but the gadolinium salt is not limited to this specific gadolinium salt. Those skilled in the art can appropriately choose a suitable gadolinium salt and reaction conditions to carry out the aforementioned reaction.

Specific methods for preparing the fluorescent gadolinium ligand compound and the fluorescent gadolinium complex compound are demonstrated in the examples mentioned in this specification, and accordingly, those skilled in the art can easily prepare the fluorescent gadolinium complex compound of the present invention by referring to the aforementioned general explanations and specific explanations in the examples with appropriately changing the starting material and reaction reagents as required.

The fluorescent gadolinium ligand compound or the fluorescent gadolinium complex compound of the present invention may have one or two or more asymmetric carbons. Any optical isomers based on one or two or more asymmetric carbons in optically pure forms, arbitrary mixtures of such optical isomers, racemates, diastereoisomers in pure forms, mixtures of diastereoisomers, and the like fall within the scope of the present invention. Further, the fluorescent gadolinium ligand compound or the fluorescent gadolinium complex compound of the present invention may exist as a hydrate or a solvate, and these substances of course also fall within the scope of the present invention.

The fluorescent gadolinium ligand compound or the fluorescent gadolinium complex compound of the present invention may also form a salt. Type of the salt is not particularly limited, and the salt may be either an acid addition salt, or a base addition salt. Examples of the acid addition salt include mineral acid salts such as hydrochlorides, sulfates, and nitrates; and organic acid salts such as acetates, methanesulfonates, citrates, p-toluenesulfonates, and oxalates. Examples of the base addition salt include metal salts such as sodium salts, potassium salts, and calcium salts, ammonium salts, and organic amine salts such as methylamine salts, and triethylamine salts. Furthermore, the compounds may form a salt of an amino acid such as glycine. However, salts of the fluorescent gadolinium ligand compound or the fluorescent gadolinium complex compound of the present invention are not limited to these specific examples.

By using the fluorescent gadolinium complex compound of the present invention as, for example, a probe or a contrast medium, imaging of a biological tissue or organ can be performed by the fluorescence method and MRI. The term “fluorescent MRI probe” or “fluorescent MRI contrast medium” used in this specification means that the compound can be used in either or both of the fluorescence method and MRI as a probe or a contrast medium. Since MRI is usually suitable for imaging of a deep part of a living body, and the fluorescence method is suitable for imaging of a shallow part, a part near the surface or the surface of a living body, those skilled in the art can appropriately choose either the fluorescence method or MRI by using the probe or the contrast medium of the present invention, or use an appropriate combination thereof to perform imaging of a living body.

In particular, the probe or the contrast medium of the present invention has a property of being easily taken up into cells and accumulated in the cells, and thus can give intense signals in imaging of a deep part of a living body by MRI to provide an extremely clear image. However, use of the probe or the contrast medium of the present invention is not limited to the imaging of a living body. Imaging of an object other than a living body, for example, tissues and organs isolated from living body, as well as cultured cell aggregates, and tissues or organs prepared in vitro for use in regenerative medicine, can be performed.

Fluorescence can be measured according to conventionally known fluorometry methods (refer to, for example, such publications as Wiersma, J. H., Anal. Lett., 3, pp. 123-132, 1970; Sawicki, C. R., Anal. Lett., 4, pp. 761-775, 1971; Damiani, P. and Burini, G., Talanta, 8, pp. 649-652, 1986; Misko, T. P., Anal. Biochem., 214, pp. 11-16, 1993; Kojima, H., Nakatsubo, N., Kikuchi, K., Kawahara, S., Kirino, Y., Nagoshi, H., Hirata, Y. and Nagano, T., Anal. Chem., 70, pp. 2446-2453, 1998; Hirano, T., Kikuchi, K., Urano, Y., Higuchi, T. and Nagano, T., J. Am. Chem. Soc., 122, pp. 12399-12400, 2000; Bremer, C., Tung, C.-H. and Weissleder, R., Nat. Med., 7, pp. 743-748, 2001; and Sasaki, E., Kojima, H., Nishimatsu, H., Urano, Y., Kikuchi, K., Hirata, Y. and Nagano, T., J. Am. Chem. Soc., 127, pp. 3684-3685, 2005). For cell imaging using the probe or the contrast medium of the present invention, for example, when the probe or contrast medium having a group represented by the general formula (I) is used, it is preferable to irradiate a light of a wavelength around 500 nm as an excitation light, and measure fluorescence of a wavelength around 510 nm. When the probe or contrast medium having a group represented by the general formula (II) is used, it is preferable to irradiate a light of a wavelength around 770 nm as an excitation light, and measure fluorescence of a wavelength around 790 nm.

For imaging of a living body using the probe or contrast medium having a group represented by the general formula (II) of the present invention, for example, it is preferable to irradiate a light of a wavelength of around 650 to 900 nm, preferably around 780 nm, as an excitation light, and measure fluorescence of a wavelength around 650 to 900 nm, preferably around 820 nm. An excitation light of such a wavelength penetrates into a biological tissue and reaches a deep part tissue without attenuation, and enables highly sensitive measurement at that site.

MRI can be performed according to a well-known method in which imaging is performed with a gadolinium contrast medium using a medical MRI apparatus utilizing proton signals. It is also possible to obtain a T1-weighted image or a T2-weighted image as required, and appropriate repetition time (TR) and echo time (TE) can be chosen so as to perform adjustment to obtain increased contrast in a target tissue or cell. For example, for a T1-weighted image, TR may be 300 to 500 milliseconds, and TE may be about 10 milliseconds, and for a T2-weighted image, TR may be 3 to 5 seconds, and TE may be 80 to 100 milliseconds. It is known that a gadolinium contrast medium has a T1 shortening effect and contrast becomes clear in a T1-weighted image after administration of a contrast medium, and therefore T1-weighted image can be easily obtained.

The method for using the probe or the contrast medium of the present invention is not particularly limited, and they can be used in the same manner as those for conventionally known MRI contrast media or fluorescence contrast media. Usually, the aforementioned fluorescent gadolinium complex compound may be dissolved in an aqueous medium such as physiological saline or buffer, a mixture of a water⁻miscible organic solvent such as ethanol, acetone, ethylene glycol, dimethyl sulfoxide and dimethylformamide, and an aqueous medium, or the like, and after the solution may be intravenously administered to a living body or added to an appropriate buffer containing cell or tissue, a fluorescence spectrum or a nuclear magnetic resonance spectrum may be measured. The probe or the contrast medium of the present invention may also be used in the form of a composition comprising appropriate additives in combination. The probe or the contrast medium of the present invention can be combined with additives such as buffers, dissolving aids, and pH modifiers.

### EXAMPLES

The present invention will be still more specifically explained with reference to examples. However, the scope of the present invention is not limited to the following examples.

### Example 1

### Synthesis of Gd-DOTA-BDP

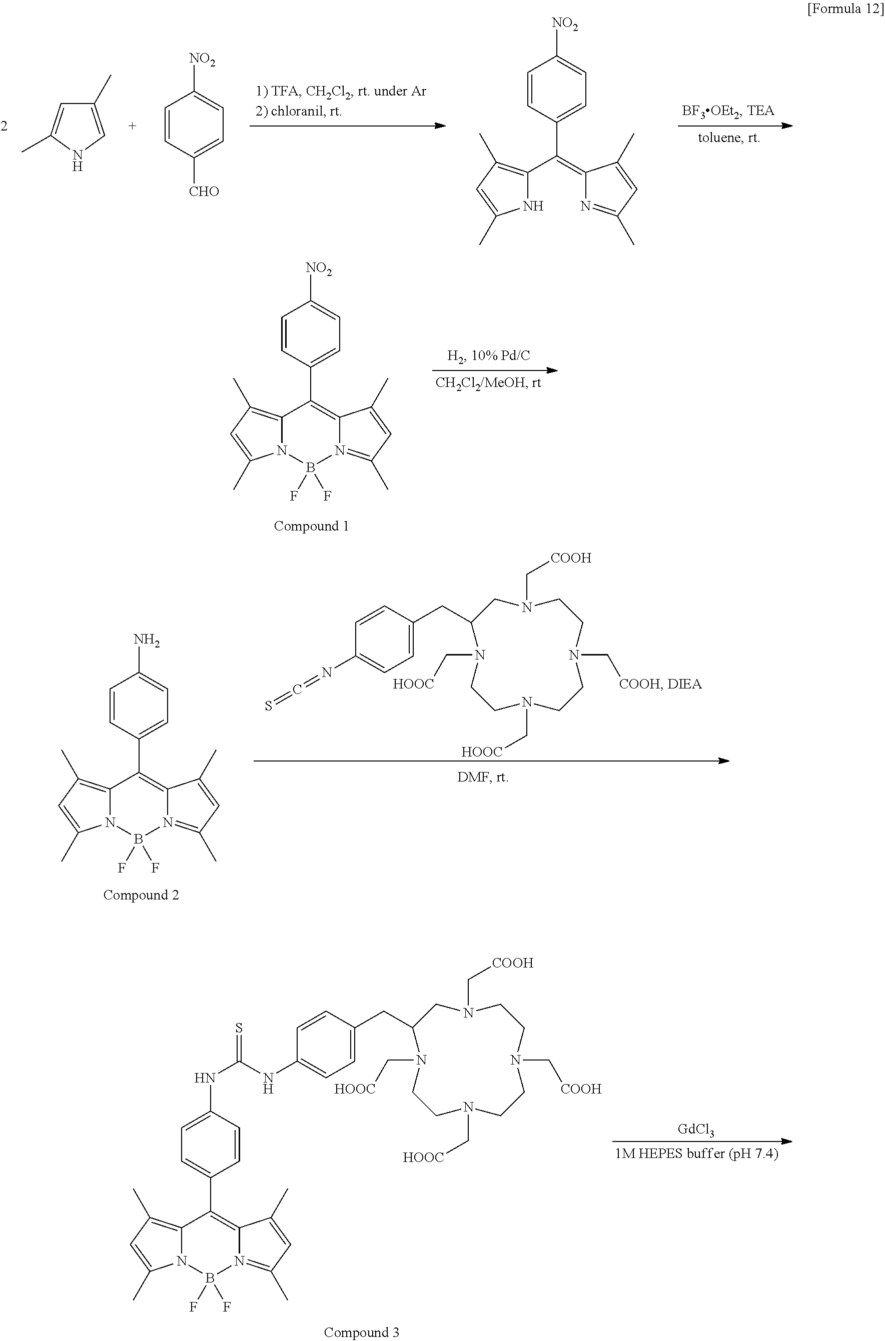

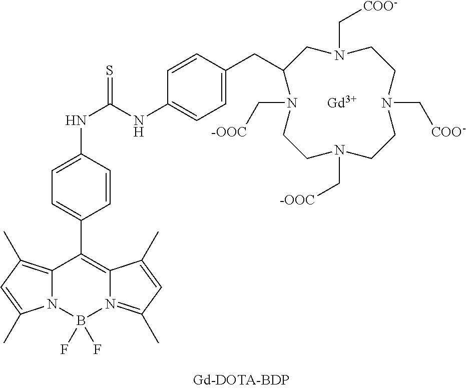

4-Nitrobenzaldehyde (1.5 g, 10 mmol) and 2,4-dimethylpyrrole (2.1 mL, 20 mmol) were dissolved in dichloromethane (1 L), the solution was added with several drops of trifluoroacetic acid, and the mixture was stirred at room temperature for 9 hours under an argon atmosphere. The reaction solution was added with chloranil (2.5 g, 10 mmol), and the mixture was further stirred for 30 minutes. After the solvent was evaporated, the residue was purified by silica gel column chromatography (NH silica, dichloromethane/n-hexane, 1:1→dichloromethane) to obtain brown solid. The obtained brown solid was dissolved in toluene (200 mL), the solution was added with triethylamine (4.2 mL, 30 mmol) and boron trifluoride.diethyl ether complex (5.0 mL, 40 mmol), and the mixture was stirred at room temperature for 2 hours. The reaction solution was washed successively with 2 N HCl, saturated aqueous sodium hydrogencarbonate and brine, the organic layer was dried over anhydrous magnesium sulfate, and the solid was removed by filtration. The solvent was evaporated, and the residue was purified by silica gel column chromatography (silica gel 60, dichloromethane/n-hexane, 1:1) to obtain Compound 1 (842 mg, 23%) as orange solid.

¹H-NMR (300 MHz, CDCl₃): δ 1.37 (s, 6H), 2.57 (s, 6H), 6.02 (s, 2H), 7.54 (d, J=8.6 Hz, 2H), 8.39 (d, J=8.6 Hz, 2H)

LRMS (ESI−): 368 (M−H)⁻

Compound 1 (842 mg, 2.3 mmol) was dissolved in dichloromethane (50 mL), the solution was added with methanol (50 mL) and 10% Pd/C (50 mg) in this order, and the mixture was stirred at room temperature for 5 hours under a hydrogen atmosphere. After the solid was removed by filtration and the solvent was evaporated, the residue was purified by silica gel column chromatography (silica gel 60, dichloromethane/n-hexane, 1:1→2:1) to obtain Compound 2 (568 mg, 73%) as orange solid.

¹H-NMR (300 MHz, CDCl₃): δ 1.49 (s, 6H), 2.54 (s, 6H), 3.83 (br s, 2H), 5.97 (s, 2H), 6.77 (d, J=8.1 Hz, 2H), 7.01 (d, J=8.1 Hz, 2H)

LRMS (ESI+): 340 (M+H)⁺, 320 (M−F)⁺

Compound 2 (50 mg, 0.15 mmol) was dissolved in dimethylformamide (DMF, 3 mL), the solution was added with a solution of p-SCN-Bn-DOTA (101 mg, 0.15 mmol) in DMF (2 mL) and N,N-diisopropylethylamine (51 μL, 0.29 mmol), and the mixture was stirred at room temperature for 16 hours. After the solvent was evaporated, the residue was purified by HPLC (ODS⁻18) to obtain Compound 3 (103 mg, 79%) as orange solid.

¹H-NMR (300 MHz, CD₃OD): δ 1.49 (s, 6H), 2.48 (s, 6H), 3.00-4.20 (m, 25H), 6.06 (s, 2H), 7.30 (d, J=8.4 Hz, 2H), 7.31 (d, J=8.2 Hz, 2H), 7.49 (d, J=8.2 Hz, 2H), 7.72 (d, J=8.4 Hz, 2H)

LRMS (ESI+): 891 (M+H)⁺

Compound 3 (50 mg, 56 μmol) was dissolved in 1 M HEPES buffer (pH 7.4, 3 mL), the solution was added with GdCl₃.6H₂O (23 mg, 62 μmol), and the mixture was stirred overnight at room temperature. After Gd(OH)₃ was precipitated by centrifugation, the solution was purified by HPLC (ODS-18) to obtain Gd-DOTA-BDP (22 mg, 34%) as orange solid.

LRMS (ESI−): 1044 (M)⁻

### Example 2

### Synthesis of Gd-DOTA-Cy

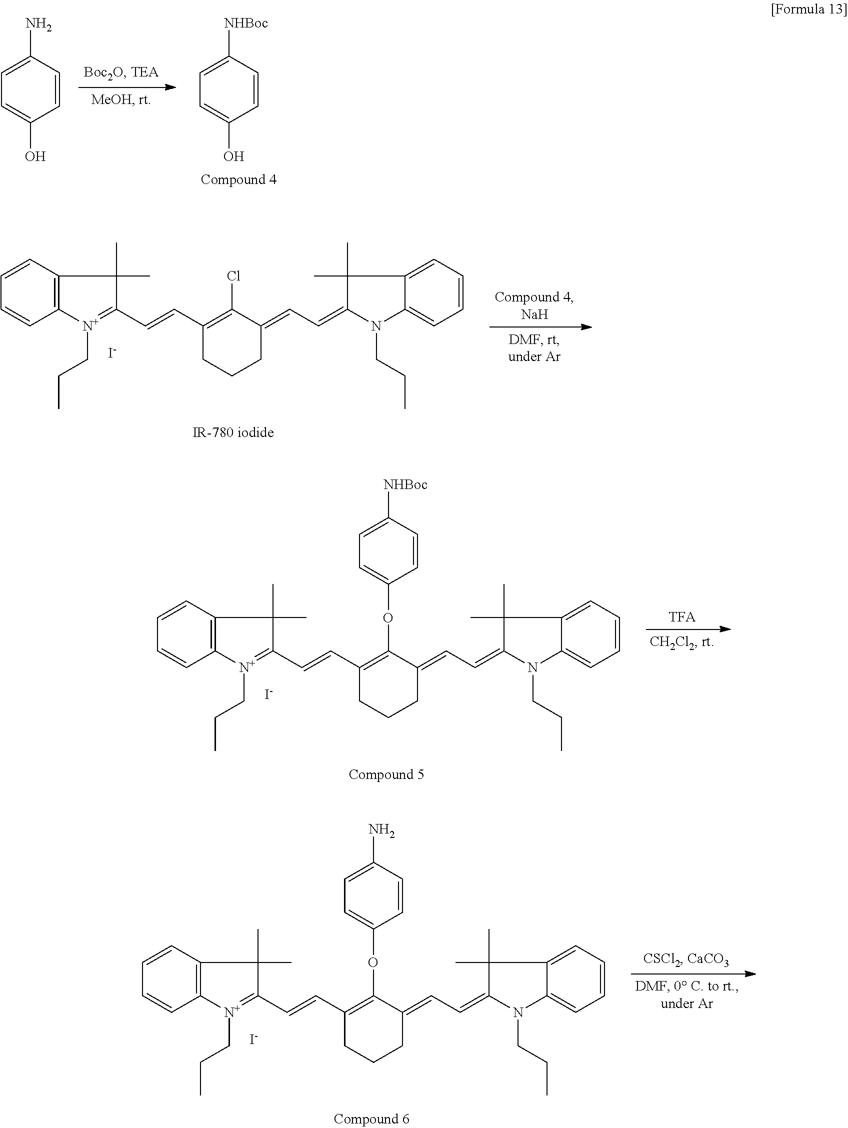

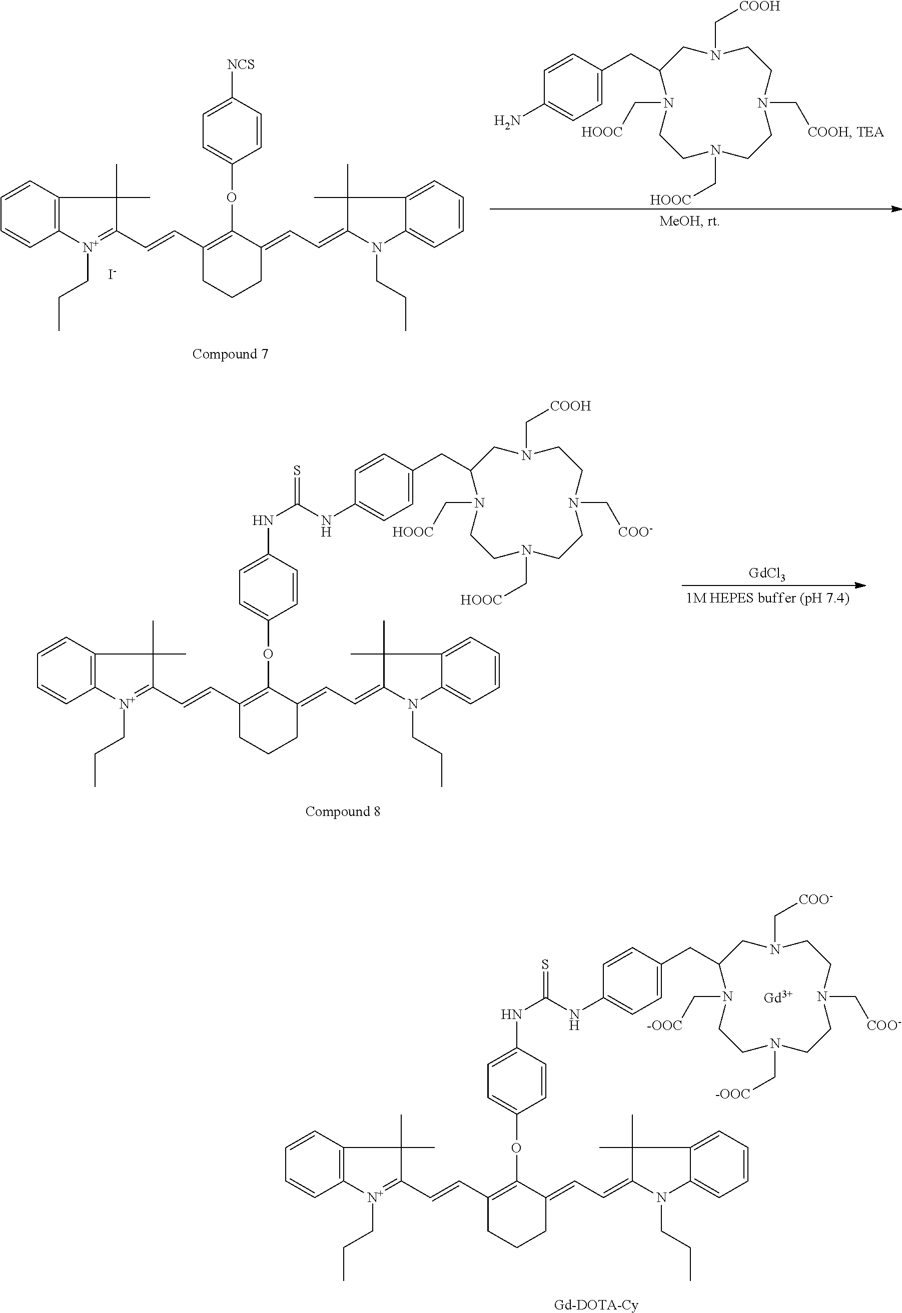

4-Aminophenol (327 mg, 3.0 mmol) was dissolved in methanol (15 mL), the solution was added with di-t-butyl dicarbonate (786 mg, 3.6 mmol) and triethylamine (625 μL, 4.5 mmol), and the mixture was stirred at room temperature for 4 hours. After the solvent was evaporated, the residue was purified by silica gel column chromatography (silica gel 60, dichloromethane/methanol, 19:1) to obtain Compound 4 (615 mg, 98%) as white solid.

^{1l H-NMR (}300 MHz, CDCl₃): δ 1.51 (s, 9H), 5.54 (s, 1H), 6.36 (br s, 1H), 6.75 (d, J=8.8 Hz, 2H), 7.18 (d, J=8.8 Hz, 2H)

Compound 4 (126 mg, 0.60 mmol) was dissolved in DMF (15 mL), the solution was added with sodium hydride (60% in oil, 24 mg, 0.60 mmol), and the mixture was stirred at room temperature for 10 minutes under an argon atmosphere. The reaction solution was added with IR⁻780 iodide (200 mg, 0.30 mmol) dissolved in DMF (15 mL), and the mixture was further stirred at room temperature for 16 hours. After the solvent was evaporated, the residue was purified by silica gel column chromatography (NH silica, dichloromethane/methanol, 19:1) to obtain Compound 5 (184 mg, 73%) as green solid.

¹H-NMR (300 MHz, CDCl₃): δ 1.05 (t, J=7.4 Hz, 6H), 1.36 (s, 12H), 1.50 (s, 9H), 1.87 (sex, J=7.4 Hz, 4H), 2.05 (t, J=5.5 Hz, 2H), 2.72 (t, J=5.5 Hz, 4H), 4.05 (t, J=7.4 Hz, 4H), 6.05 (d, J=14.3 Hz, 2H), 6.80 (br s, 1H), 6.99 (d, J=9.0 Hz, 2H), 7.09 (d, J=7.7 Hz, 2H), 7.20 (d, J=7.7 Hz, 2H), 7.27 (d, J=6.8 Hz, 2H), 7.34 (d, J=6.8 Hz, 2H), 7.47 (d, J'29.0 Hz, 2H), 7.91 (d, J=14.3 Hz, 2H)

LRMS (ESI⁺): m/z 712 (M−I)⁺

Compound 5 (118 mg, 0.14 mmol) was dissolved in dichloromethane (2.5 m1^{.}4), the solution was added with trifluoroacetic acid (0.5 mL), and the mixture was stirred at room temperature for 2 hours. After the solvent was evaporated, the reaction mixture was added with toluene, and trifluoroacetic acid was removed by azeotropy. The residue was purified by silica gel column chromatography (NH silica, CH2Cl₂/MeOH, 9:1) to obtain Compound 6 (99 mg, 95%) as deep red solid.

¹H-NMR (300 MHz, CDCl₃): δ 1.03 (t, J=7.4 Hz, 6H), 1.38 (s, 12H), 1.86 (sex, J=7.4 Hz, 4H), 2.02 (t, J=5.8 Hz, 2H), 2.67 (t, J=5.8 Hz, 4H), 4.00 (t, J=7.4 Hz, 4H), 6.01 (d, J=14.3 Hz, 2H), 6.70 (d, J=8.8 Hz, 2H), 6.85 (d, J=8.8 Hz, 2H), 7.06 (d, J=7.6 Hz, 2H), 7.19 (d, J=7.6 Hz, 2H), 7.27 (d, J=6.4 Hz, 2H), 7.34 (td, J=7.6, 1.2 Hz, 2H), 7.96 (d, J=14.3 Hz, 2H)

LRMS (ESI+): m/z 612 (M−I)⁺

Compound 6 (42 mg, 57 μmol) was dissolved in DMF (15 mL), the solution was added with sodium carbonate (60 mg, 570 μmol), and the mixture was cooled to 0° C. under an argon atmosphere. The mixture was slowly added dropwise with thiophosgene (43 μL, 570 μmol) using a syringe, and the mixture was returned to room temperature, and stirred for 1 hour. After the solvent was evaporated, the residue was purified by silica gel column chromatography (silica gel 60, dichloromethane/methanol, 9:1) to obtain Compound 7 (34 mg, 75%) as deep red solid.

¹H-NMR (300 MHz, CDCl₃): δ 1.04 (t, J=7.4 Hz, 6H), 1.35 (s, 12H), 1.86 (sex, J=7.4 Hz, 4H), 2.04 (t, J=5.8 Hz, 2H), 2.72 (t, J=5.8 Hz, 4H), 4.07 (t, J=7.4 Hz, 4H), 6.13 (d, J=14.3 Hz, 2H), 7.06 (d, J=8.8 Hz, 2H), 7.09 (d, J=8.8 Hz, 2H), 7.17-7.28 (m, 6H), 7.36 (t, J=7.6 Hz, 2H), 7.79 (d, J=14.3 Hz, 2H)

LRMS (ESI⁺): m/z 654 (M−I)⁺

Compound 7 (20 mg, 25 μmol) was dissolved in methanol (2 mL), the solution was added with triethylamine (33 μL, 240 μmol) and p-NH₂-Bn-DOTA (12 mg, 24 μmol), and the mixture was stirred at room temperature for 21 hours. After the solvent was evaporated, the residue was purified by HPLC (ODS-18) to obtain Compound 8 (11 mg, 36%) as green solid.

¹H-NMR (300 MHz, CDCl₃): δ 1.01 (t, J=7.4 Hz, 6H), 1.39 (s, 12H), 1.83 (sex, J=7.4 Hz, 4H), 2.05 (t, J=5.8 Hz, 2H), 2.60-4.30 (m, 25H), 2.74 (t, J=5.8 Hz, 4H), 4.07 (t, J=7.4 Hz, 4H), 6.16 (d, J=14.3 Hz, 2H), 7.12 (d, J=8.8 Hz, 2H), 7.20 (t, J=7.6 Hz, 2H), 7.24-7.49 (m, 12H), 8.01 (d, J=14.3 Hz, 2H) LRMS (ESI⁺): m/z 1163 (M-CF₃COO)⁺

Compound 8 (11 mg, 8.5 μmol) was dissolved in 1 M HEPES buffer (pH 7.4, 2 mL), the solution was added with GdCl₃.6H₂O (3.8 mg, 10 μmol), and the mixture was stirred at room temperature for 18 hours. The reaction solution was purified by HPLC (ODS-18) to obtain green solid (7.0 mg, 62%).

HRMS Calcd for [M+CF₃COO]⁻: 1430.47821, found: 1430.48668 (+8.48 mmu).

### Example 3

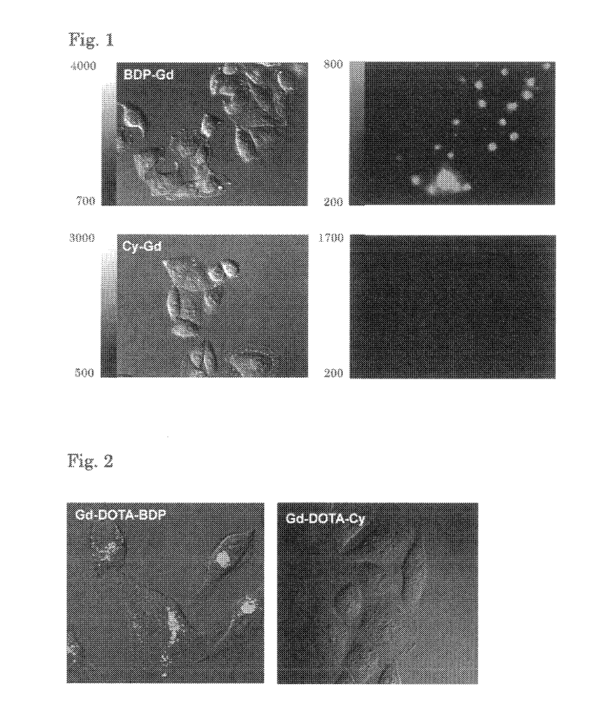

Gd-DOTA-BDP and Gd-DOTA-Cy obtained in Examples 1 and 2 were introduced into the HeLa cells, and fluorescence imaging was performed. Optical and fluorescence microscope images of the HeLa cells treated with each of the probes for 2 hours are shown in FIG. 1, and confocal images of the same are shown in FIG. 2. It was observed that both Gd-DOTA-BDP and Gd-DOTA-Cy were introduced into the cells from the fluorescence microscope images. From the confocal images, it is considered that both Gd-DOTA-BDP and Gd-DOTA-Cy accumulated in organelles near nuclei. The cells survived after introduction of each probe, and it was considered that both probes did not have significant cytotoxicity.

### Example 4

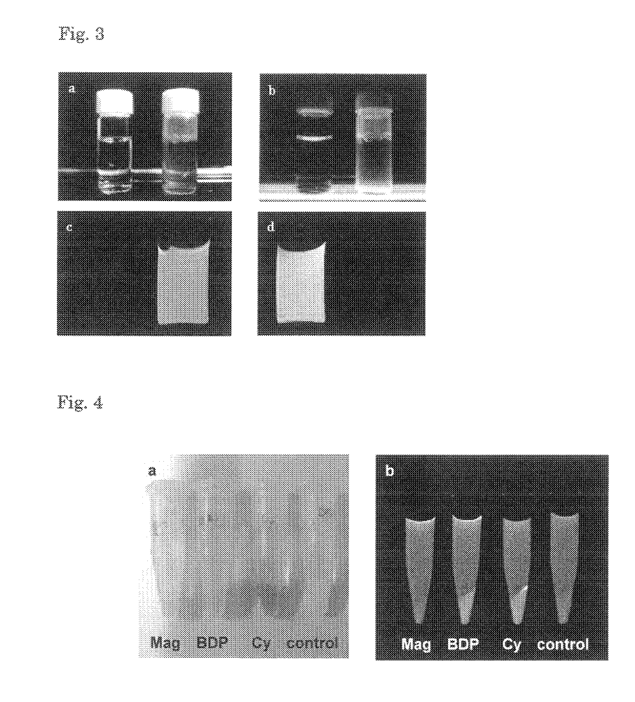

A solution of Gd-DOTA-BDP obtained in Example 1 in a PBS buffer was prepared, and subjected to MRI. In each photograph shown in FIG. 3, the PBS buffer is shown on the left side, and the PBS buffer containing Gd-DOTA-BDP is shown on the right side. The image of “a” is an image under an ordinary light, the image of “b” is a fluorescence image, the image of “c” is an MR image (T1-weighted), and the image of “d” is an MR image (T2-weighted). As shown in FIG. 3a, Gd-DOTA-BDP can significantly shorten T1, and weight signals in T1-weighted images among the MR images.

### Example 5

Each of Gd-DOTA-BDP (Example 1), Gd-DOTA-Cy (Example 2), and “Magnevist (registered trademark)” was added to a HeLa cell culture medium (DMEM) at a concentration of 100 μM, and the medium was incubated for 2 hours so that they were introduced into the cells, and then the cells were subjected to MRI. Among the photographs shown in FIG. 4, the photograph of “a” shows an image under an ordinary light, and the photograph of “b” shows an MR image (T1-weighted, T_{R}/T_{E}=600 ms/14 ms). Among the tubes, those of Mag show the results obtained with the commercially available MRI contrast medium, Magnevist (registered trademark), those of BDP show the results obtained with Gd-DOTA-BDP (Example 1), and those of Cy show the results obtained with Gd-DOTA-Cy (Example 2). “Magnevist (registered trademark)” currently clinically used as an MRI contrast medium was not taken up into the inside of the cells, and accordingly signal intensity was similar to that of the control prepared without adding Gd-DOTA-BDP, Gd-DOTA-Cy or “Magnevist (registered trademark)”. On the other hand, with Gd-DOTA-BDP and Gd-DOTA-Cy, stronger signals were observed compared with those obtained with “Magnevist (registered trademark)”.

### Example 6

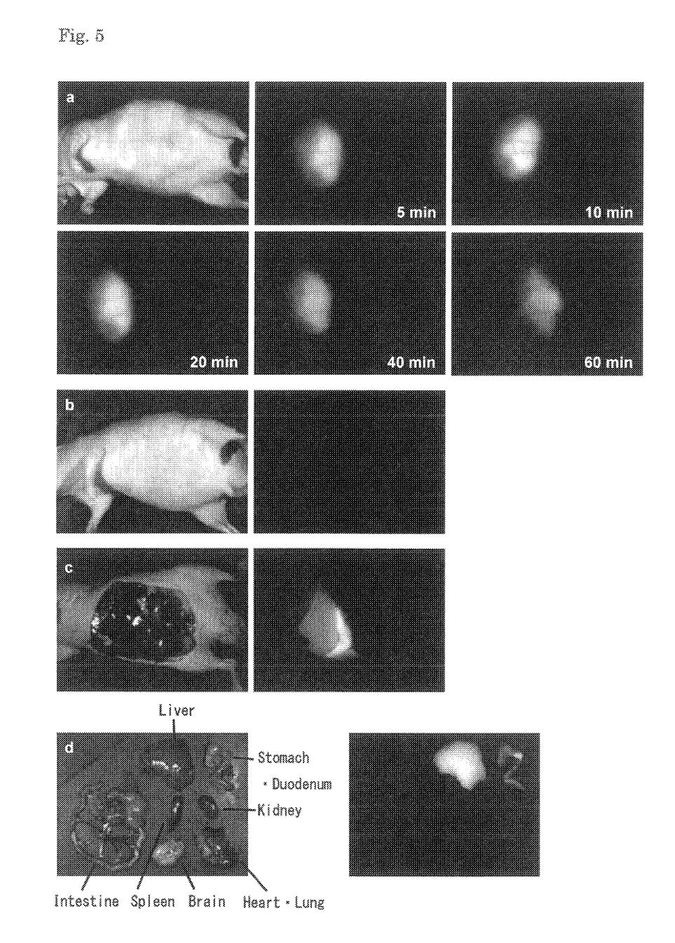

Gd-DOTA-Cy (Example 2) (100 μM in 100 μL of physiological saline) was injected into a nude mouse from the caudal vein, and in vivo fluorescence imaging was performed at an excitation wavelength of 670 to 750 nm and a fluorescence emission wavelength of 820 nm. Among the photographs shown in FIG. 5, the photographs of “a” show images of a Gd-DOTA-Cy-administered mouse obtained by externally performed fluorescence imaging, the photographs of “b” show images of a mouse to which Gd-DOTA-Cy was not administered obtained by externally performed fluorescence imaging, the photographs of “c” show images of the incised abdominal part obtained by fluorescence imaging, and the photographs of “d” show images of isolated organs obtained by fluorescence imaging.

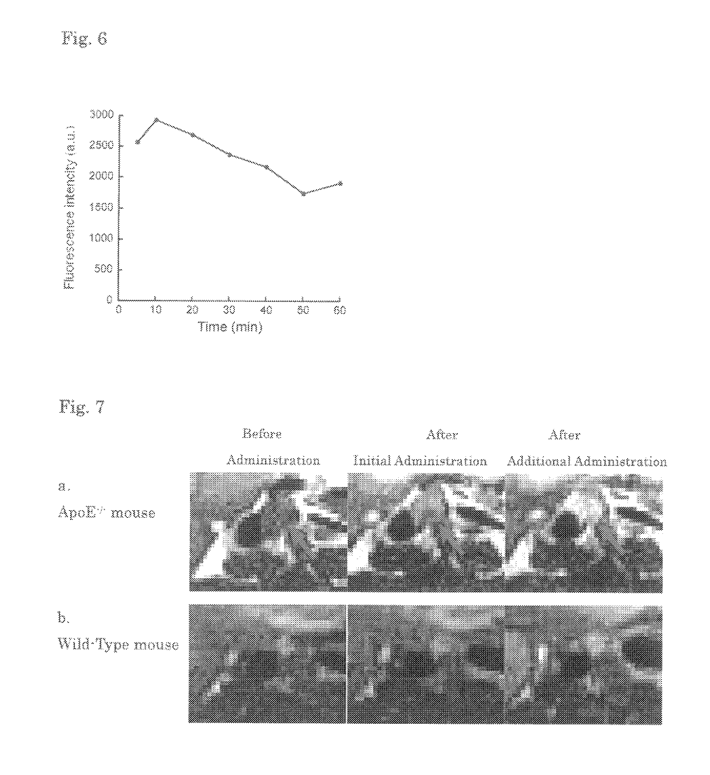

As shown in FIG. 5a, since Gd-DOTA-Cy shows absorption for light of the near infrared region, fluorescence imaging was possible even from the outside of the body. From the fluorescence image of incised abdomen (FIG. 5c) and the fluorescence image of isolated organs (FIG. 5d), it was observed that Gd-DOTA-Cy promptly accumulated in the liver after the administration. Further, when temporal change of the fluorescence intensity was observed in the external fluorescence imaging (FIG. 5a), it was observed that fluorescence intensity enabling fluorescence imaging was maintained for a sufficient period of time (FIG. 6).

### Example 7

MRI was performed for aortas of an arteriosclerosis model mouse, ApoE⁻/⁻mouse, and a wild-type mouse, to both of which Gd-DOTA-BDP (Example 1) was administered. MRI was performed after each mouse was anesthetized with isoflurane, to which 100 μL of a Gd-DOTA-BDP solution (5 mM) in physiological saline was administered and additionally 150 μL of the same 2 hours later from the orbital vein was also administered. MRI measurement was performed before the administration of Gd-DOTA-BDP, and 1 hour after each administration of Gd-DOTA-BDP (measurement conditions, TR: 500 ms, TE: 13.2 ms, TI: 250 ms, Black Blood sequence). The results are shown in FIG. 7. In FIG. 7, the images of “a” on the upper part show the results for the ApoE⁻/⁻mouse, which is an arteriosclerosis model mouse, and the images of “b” on the lower part show the results for the wild-type mouse, including those obtain before the administration (left), after the administration (center), and after the additional administration (right). As shown in FIG. 7a, it was observed that, in the ApoE⁻/⁻mouse, which is an arteriosclerosis model mouse, Gd-DOTA-BDP penetrated the capsule covering arteriosclerotic lesion and accumulated in the arteriosclerotic lesion in the portion indicated with an arrow to enhance MRI signals of the arteriosclerotic lesion. On the other hand, as shown in FIG. 7b, enhancement of MRI signals was not observed in the same experiment performed as a control for the wild-type mouse without arteriosclerotic lesion. It is known that the fluorescent dye, boron dipyrromethene (BDP), selectively accumulates in lipid droplets in white fat cells due to the hydrophobicity thereof. The above results indicate that since the constituents of lipid droplets and arteriosclerotic lesions are similar, Gd-DOTA-BDP having the BDP moiety accumulated in the arteriosclerotic lesion and thereby enhanced the MRI signals, and thus it was revealed that arteriosclerotic lesions could be detected by MRI using Gd-DOTA-BDP.

### Example 8

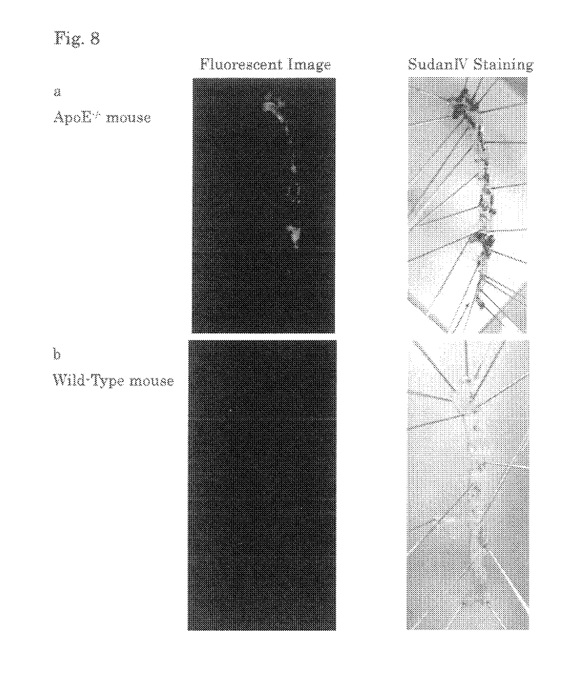

After completion of the MRI experiment of Example 7, the aortas were isolated from the mice, cut open and subjected to fluorescence imaging performed by using a fluorescence imaging apparatus (Maestro (registered tread mark)), measurement conditions, excitation wavelength: 445 to 490 nm, fluorescence emission wavelength: 520 to 800 nm). After fluorescence images were obtained, arteriosclerotic lesions were further stained with Sudan IV. Sudan IV is a dye generally used for staining arteriosclerotic lesions of isolated aorta. The results are shown in FIG. 8. In FIG. 8, the images of “a” on the upper part show the results for the arteriosclerosis model mouse, ApoE⁻/⁻mouse, and the images of “b” on the lower part show the results for the wild-type mouse. The fluorescence images are shown on the left side, and the Sudan IV staining images are shown on the right side. As shown in FIG. 8a, in the ApoE⁻/⁻mouse, which is an arteriosclerosis model mouse, Gd-DOTA-BDP accumulated in the arteriosclerotic lesion stained with Sudan IV, and fluorescence was selectively observed in the arteriosclerotic lesion. Whilst, as shown in FIG. 8b, in the same experiment performed for a wild-type mouse as a control, neither the arteriosclerotic lesion nor fluorescence of Gd-DOTA-BDP was observed.

### Example 9

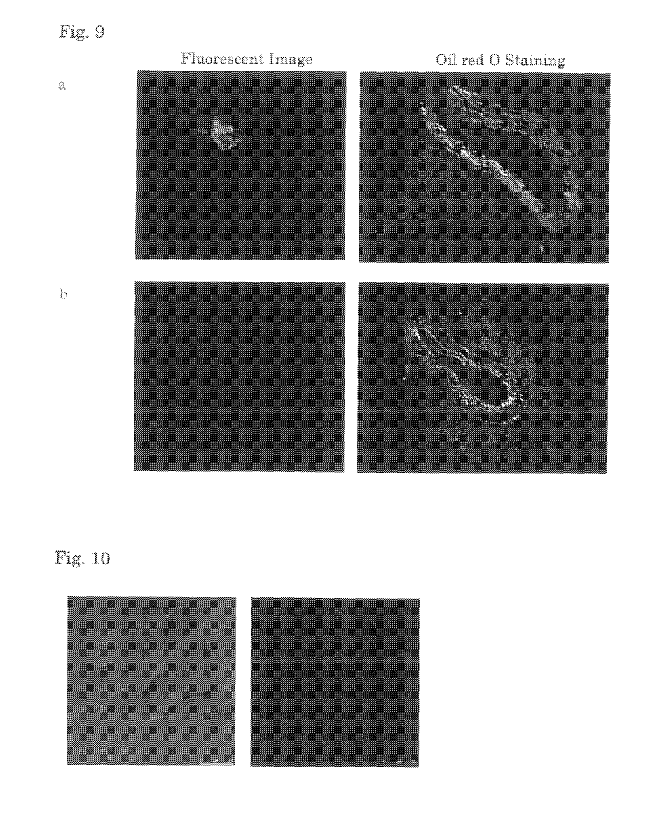

After completion of the MRI experiment of Example 7, frozen sections of the aorta portion where enhancement of MRI signals was observed and the aorta portion where any signal change was not observed were prepared, and subjected to fluorescence imaging performed with a fluorescence microscope (measurement conditions, excitation wavelength: 500 nm, fluorescence emission wavelength: 505 to 600 nm). After fluorescence images were obtained, arteriosclerotic lesions were stained with Oil red O. Oil Red O is a dye generally used for staining arteriosclerotic lesions of aorta sections. The results are shown in FIG. 9. In FIG. 9, the images of “a” on the upper part show the results for a frozen section of the aorta portion where enhancement of MRI signals was observed, and the images of “b” on the lower part show the results for a frozen section of the aorta portion where any signal change was not observed. The fluorescence images are shown on the left side, and the Oil Red O staining images are shown on the right side. As shown in FIG. 9a, in the frozen section of the part where enhancement of MRI signals was observed, fluorescence of Gd-DOTA-BDP and Oil Red O stained image were selectively observed in the arteriosclerotic lesion. Whilst, as shown in FIG. 9b, in the frozen section of the part where MRI signal change was not observed, neither arteriosclerotic lesion nor fluorescence of Gd-DOTA-BDP was observed.

The results of Examples 8 and 9 revealed that an arteriosclerotic lesion could also be selectively detected by fluorescence using Gd-DOTA-BDP, in addition to that an arteriosclerotic lesion could be detected by MRI using Gd-DOTA-BDP.

### Example 10

### Synthesis of Gd-DOTA-PEG-Cy

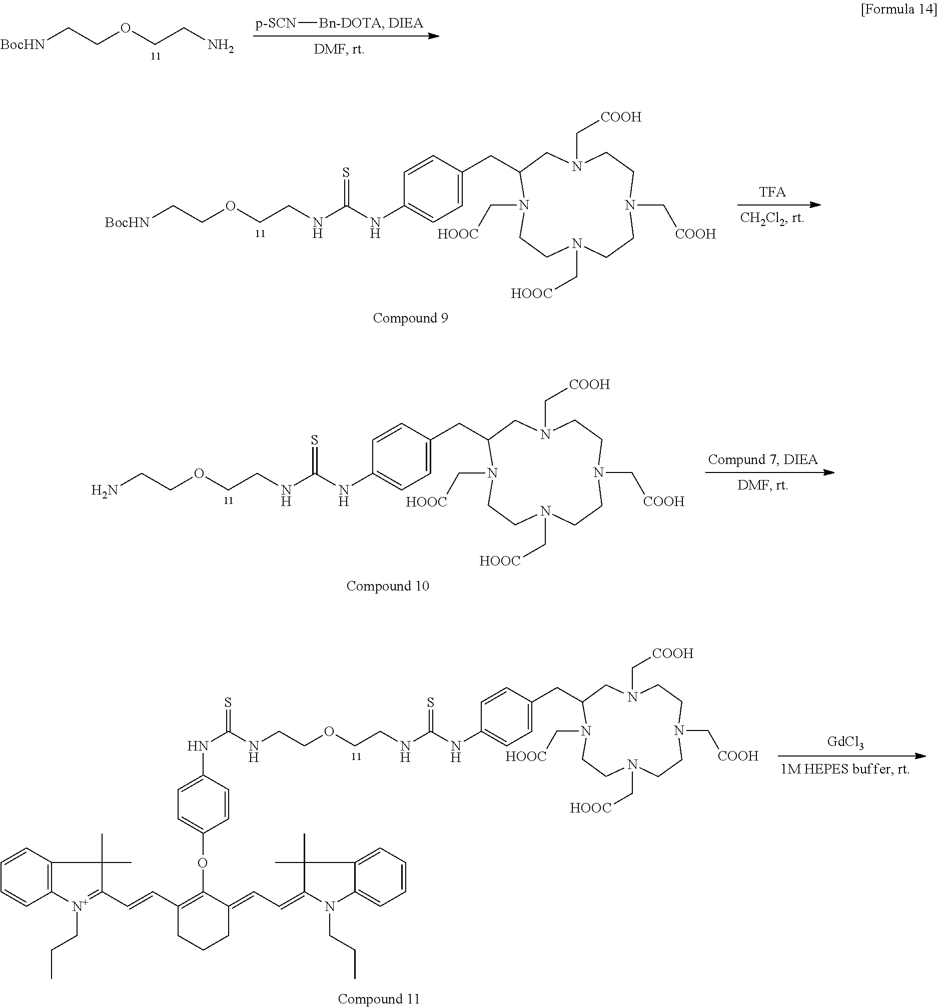

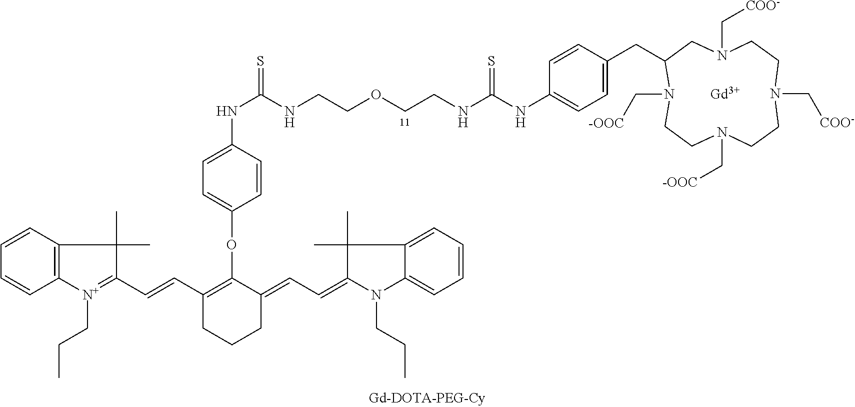

O-(2-Aminoethyl)-O′-[2-(Boc-amino)ethyl]decaethylene glycol (161 mg, 0.25 mmol) was dissolved in DMF (4.5 mL), the solution was added with N,N-diisopropylethylamine (435 μL, 2.5 mmol) and p-SCN-Bn-DOTA (154 mg, 0.28 mmol), and the mixture was stirred at room temperature for 50 hours. After the solvent was evaporated, the residue was purified by HPLC (ODS-18) to obtain Compound 9 (281 mg, 94%) as white solid.

MS (ESI+): m/z 1196 (M+H)⁺

Compound 9 (276 mg, 0.23 mmol) was dissolved in dichloromethane (4 mL), the solution was added with trifluoroacetic acid (7 mL), and the mixture was stirred at room temperature for 5 hours. After the solvent was evaporated, the residue was purified by HPLC (ODS-18) to obtain Compound 10 (227 mg, 90%) as white solid.

MS (ESI⁺): m/z 1096 (M+H)⁺

Compound 7 (118 mg, 0.11 mmol) was dissolved in DMF (4 mL), the solution was added with N,N-diisopropylethylamine (174 μL, 1.0 mmol) and Compound 10 (110 mg, 0.10 mmol), and the mixture was stirred overnight at room temperature. After the solvent was evaporated, the residue was purified by HPLC (ODS-18) to obtain Compound 11 (54 mg, 31%) as green solid.

¹H-NMR (300 MHz, CDCl₃): δ 0.92 (t, J=7.5 Hz, 6H), 1.30 (s, 12H), 1.74 (sex, J=7.5 Hz, 4H), 1.95 (s, 2H), 2.51-4.19 (m, 6H), 6.07 (d, J=13.9 Hz, 2H), 7.03 (d, J=9.2 Hz, 2H), 7.12 (t, J=7.5 Hz, 2H), 7.18 (t, J=7.7 Hz, 4H), 7.26-7.35 (m, 8H), 7.91 (d, J=13.9 Hz, 4H); MS (ESI⁺): m/z 1749 (M)⁺

Compound 11 (10 mg, 5.9 μmol) was dissolved in 1 M HEPES buffer (pH 7.4, 2 mL), the solution was added with GdCl₃.6H₂O (3.3 mg, 8.8 μmol), and the mixture was stirred at room temperature for 24 hours. The reaction solution was added with acetonitrile, and the upper layer was extracted, concentrated, and then purified by HPLC (ODS-18) to obtain Gd-DOTA-PEG-Cy (6.9 mg, 62%) as green solid.

HRMS (ESI⁻): Calcd for [M+H]⁻: 1904.81452, found: 1904.81110 (−3.43 mmu)

### Example 11

Gd-DOTA-PEG-Cy obtained in Example 10 was introduced to the HeLa cells, and subjected to fluorescence imaging. In FIG. 10, there are shown the results of optical and confocal fluorescence microscope observation of the HeLa cells treated with 10 μM Gd-DOTA-PEG-Cy. A transmission image is shown on the left side, and a confocal fluorescence microscope image (measurement conditions, excitation wavelength: 670 nm, fluorescence emission wavelength: 700 to 800 nm) is shown on the right side. From the confocal fluorescence microscope image, it was observed that Gd-DOTA-PEG-Cy was successfully introduced into the cells. Gd-DOTA-PEG-Cy showed increased water solubility compared with Gd-DOTA-Cy due to introduction of the PEG chain, thus made preparation of a Gd-DOTA-Cy aqueous solution easier, and also showed higher cell introducibility compared with Gd-DOTA-Cy. Further, the cells to which Gd-DOTA-PEG-Cy was introduced survived, and thus it was considered that the probe did not have significant cytotoxicity.

### Example 12

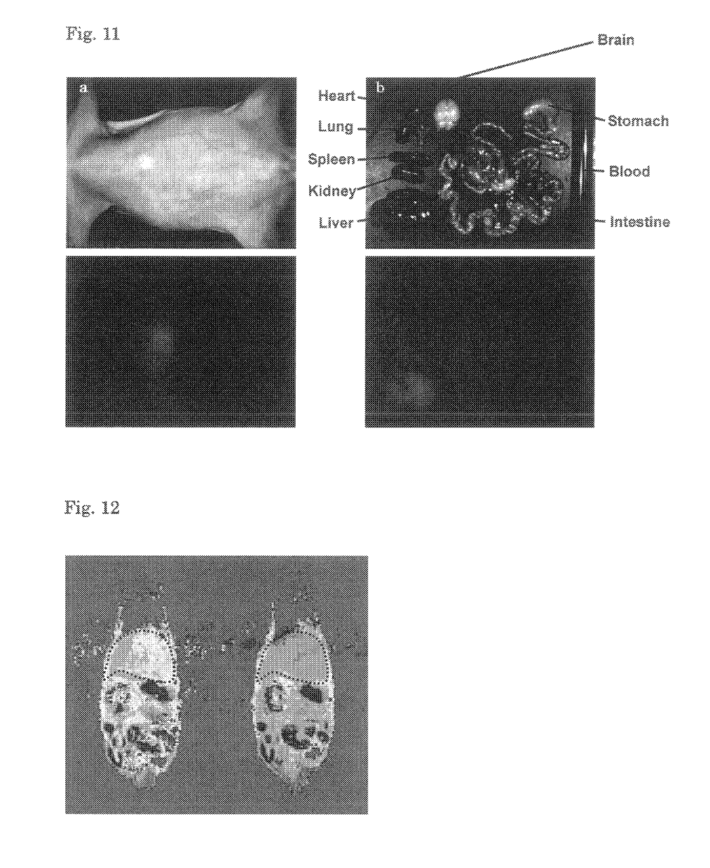

Gd-DOTA-PEG-Cy (Example 10) was injected into a nude mouse from the caudal vein, and the kinetics of Gd-DOTA-PEG-Cy was observed by fluorescence imaging. The fluorescence imaging was performed after the nude mouse (8-week old, male) was anesthetized by intraperitoneal injection of Nembutal (30 μL), and 100 μL of Gd-DOTA-PEG-Cy dissolved in physiological saline (100 μM) was administered from the caudal vein. In FIG. 11, there are shown the results of fluorescence imaging performed from the outside of the body using a fluorescence imaging apparatus (Maestro (registered trade mark)) and observation of fluorescence of organs isolated from the nude mouse sacrificed with CO₂ 1 hour after the administration of Gd-DOTA-PEG-Cy and incised in the abdomen (measurement conditions, excitation wavelength: 670 to 750 nm, fluorescence emission wavelength: 780 to 900 nm). Among the photographs of FIG. 11, the photographs of “a” show the results of externally performed fluorescence imaging of the Gd-DOTA-PEG-Cy-administered mouse, and the photographs of “b” show the results of fluorescence imaging of organs isolated from the Gd-DOTA-PEG-Cy-administered mouse. It was observed that Gd-DOTA-PEG-Cy promptly accumulated in the liver after the administration (FIG. 11b). Further, it was observed that fluorescence intensity enabling fluorescence imaging was sufficiently maintained in the fluorescence imaging performed from the outside of the body (FIG. 11a).

### Example 13

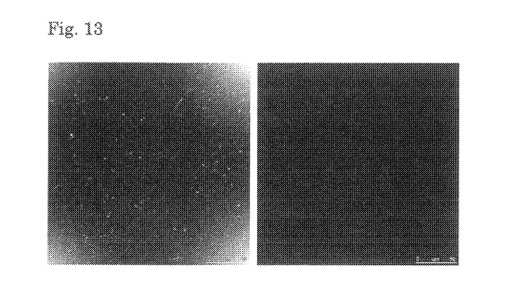

A nude mouse was injected with Gd-DOTA-PEG-Cy (Example 10) from the caudal vein, and the inside of the body of the mouse was imaged by MRI. MRI was performed after the mouse was anesthetized with isoflurane (1.5 to 2%), to which 100 μL of Gd-DOTA-PEG-Cy (5 mM) dissolved in physiological saline was administered from the orbital vein. MRI measurement was performed before and after the administration of Gd-DOTA-PEG-Cy (measurement conditions, TR: 7000, 2000, 1000, 600, 300, 200, 150 and 100 ms, TE: 9.8 ms, flip angle (FA): 131 degrees, effective bandwidth: 100 KHz, slice thickness: 1 mm, field of view (FOV): 80×50 mm², in-plane resolution: 0.39 mm, matrix size: 128×128, number of signal averages: 1, number of segment: 1). The results are shown in FIG. 12. In FIG. 12, the MRI measurement result obtained before the administration of Gd-DOTA-PEG-Cy is shown on the left side, and the MRI measurement result obtained after the administration of Gd-DOTA-PEG-Cy is shown on the right side. In FIG. 12, significant shortening of the longitudinal relaxation time T1 was observed in the part enclosed with the dotted line of the T1 map after the administration of Gd-DOTA-PEG-Cy. This was induced by Gd-DOTA-PEG-Cy accumulated in the liver, and it was demonstrated that change of the liver could be visualized at high sensitivity by MRI using Gd-DOTA-PEG-Cy.

### Example 14

Gd-DOTA-PEG-Cy (Example 10) was injected into a nude mouse from the caudal vein, then the liver was isolated from the mouse, and a frozen section was prepared from the liver, and subjected to fluorescence imaging performed with a confocal microscope. The fluorescence imaging using a confocal microscope was performed according to the following procedure: 1) the nude mouse (8-week old, male) was anesthetized by intraperitoneal injection of Nembutal (30 μL) 100 μL of a solution of Gd-DOTA-PEG-Cy dissolved in physiological saline (5 mM) was administered to the mouse from the orbital vein, 3) the mouse was sacrificed with CO₂ 30 minutes after the administration of Gd-DOTA-PEG-Cy, blood was drained from the heart, then physiological saline was injected into the heart to flush the blood, the liver was isolated, 4) the isolated liver was washed three times with PBS, and frozen, a section (10 μm) was prepared from it, and 5) the prepared section was place on slide glass, cover glass was put on it, and measurement was performed (measurement conditions, excitation wavelength: 670 nm, fluorescence emission wavelength: 700 to 800 nm). The results are shown in FIG. 13. A transmission image is shown on the left side, and a confocal fluorescence microscope image is shown on the right side. In the photograph on the right side of FIG. 13, near-infrared fluorescence originating in Gd-DOTA-PEG-Cy was observed from the hepatocyte slice with sufficient intensity, and thus it was confirmed that Gd-DOTA-PEG-Cy was taken up into the hepatocytes.

The results obtained in Examples 11, 12, 13 and 14 indicate that Gd-DOTA-PEG-Cy is efficiently taken up into hepatocytes in a liver in vivo, and that it is possible to visualize a intrahepatic state in vivo by MRI and fluorescence.

As described above, it was observed that the fluorescent MRI probe of the present invention comprising a specific fluorescent dye having a group represented by the general formula (I) or (II) and a gadolinium complex in combination had superior cell migration property without using such a means as CPP and dextran. In addition, it was also observed that after the probe was easily taken up into cells, the probe enabled dual imaging by the fluorescence method and MRI.

1. A fluorescent gadolinium complex compound comprising a residue of gadolinium.1,4,7,10-tetraazacyclododecane-N,N′,N″,N′″-tetraacetic acid which may have a substituent or a residue of gadolinium.diethylenetriaminepentaacetic acid which may have a substituent, wherein said residue is covalently bound with a group represented by the following general formula (I): 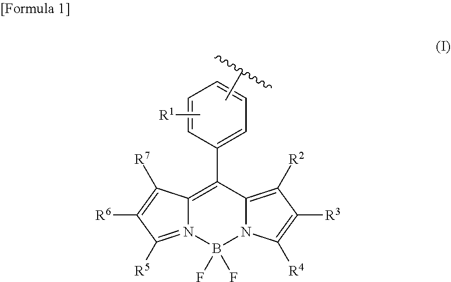
wherein R¹ represents hydrogen atom or 1 to 4 substituents existing at arbitrary positions on the benzene ring (when there are two or more substituents, they may be the same or different); R², R⁴, R⁵ and R⁷ independently represent hydrogen atom, a halogen atom or a C₁₋₆ alkyl group which may have a substituent, and R³ and R⁶ independently represent hydrogen atom, a halogen atom or a C₁₋₆ alkyl group which may have a substituent, or a group represented by the following general formula (II): 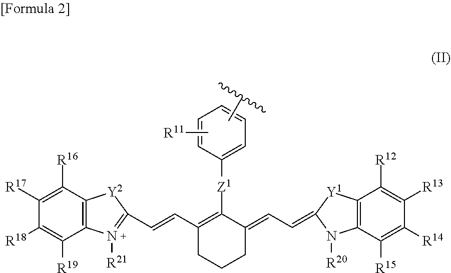
wherein R^{H} represents hydrogen atom or 1 to 4 substituents existing at arbitrary positions on the benzene ring (when there are two or more substituents, they may be the same or different); R¹², R¹³, R¹⁴, R¹⁵, R¹⁶, R¹⁷, R¹⁸ and R¹⁹ independently represent hydrogen atom, a halogen atom or a C₁₋₆ alkyl group which may have a substituent; R²⁰ and R²¹ independently represent a C₁₋₁₈ alkyl group which may have a substituent; Z¹ represents oxygen atom, sulfur atom or —N(R²²)— (in the formula, R²² represents hydrogen atom or a C₁₋₆ alkyl group which may have a substituent); Y¹ and Y² independently represent —C(═O)—, —C(═S)— or —C(R²³)(R²⁴)— (in the formula, R²³ and R²⁴ independently represent a C₁₋₆ alkyl group which may have a substituent); and M⁻ represents a counter ion in a number required for neutralizing electrical charge.

2. The fluorescent gadolinium complex compound according to claim 1, wherein the residue of gadolinium.1,4,7,10-tetraazacyclododecane-N,N′,N″,N′″-tetraacetic acid which may have a substituent or the residue of gadolinium.diethylenetriaminepentaacetic acid which may have a substituent is a residue of gadolinium.1,4,7,10-tetraazacyclododecane-N,N′,N″,N′″-tetraacetic acid having p-thioureidobenzyl group or an ester thereof or a residue of gadolinium.diethylenetriaminepentaacetic acid having p-thioureidobenzyl group or an ester thereof.

3. The fluorescent gadolinium complex compound according to claim 1, wherein a group represented by the general formula (I) in which R¹ is hydrogen atom, R², R⁴, R⁵ and R⁷ are methyl groups, and R³ and R⁶ are hydrogen atoms, or a group represented by the general formula (II) in which R¹¹ is hydrogen atom, R¹³, R¹⁴, R¹⁵, R¹⁶, R¹⁷, R¹⁸ and R¹⁹ are hydrogen atoms, R²⁰ and R²¹ are C₁₋₆ alkyl groups, Z¹ is oxygen atom, and Y¹ and Y² are —C(R²³)(R²⁴)— (in the formula, R²³ and R²⁴ are independently C₁₋₆ alkyl groups) is bound via a covalent bond.

4. A fluorescent MRI probe comprising the fluorescent gadolinium complex compound according to claim 1 as an active ingredient.

5. A fluorescent MRI contrast medium comprising the fluorescent gadolinium complex compound according to claim 1 as an active ingredient.

6. A fluorescent gadolinium ligand compound comprising a residue of 1,4,7,10-tetraazacyclododecane-N,N′,N″,N′″-tetraacetic acid which may have a substituent or a residue of diethylenetriaminepentaacetic acid which may have a substituent, wherein said residue is covalently bound with a group represented by the general formula (I) or (II) mentioned in claim 1.

7. The fluorescent gadolinium complex compound according to claim 2, wherein a group represented by the general formula (I) in which R¹ is hydrogen atom, R², R⁴, R⁵ and R⁷ are methyl groups, and R³ and R⁶ are hydrogen atoms, or a group represented by the general formula (II) in which R ¹¹ is hydrogen atom, R¹², R¹³, R¹⁴, R¹⁵, R¹⁶, R¹⁷, R¹⁸ and R¹⁹ are hydrogen atoms, R²⁰ and R²¹ are C₁₋₆ alkyl groups, Z¹ is oxygen atom, and Y¹ and Y² are —C(R²³)(R²⁴)— (in the formula, R²³ and R²⁴ are independently C₁₋₆ alkyl groups) is bound via a covalent bond.

8. A fluorescent MRI probe comprising the fluorescent gadolinium complex compound according to claim 2 as an active ingredient.

9. A fluorescent MRI probe comprising the fluorescent gadolinium complex compound according to claim 3 as an active ingredient.

10. A fluorescent MRI probe comprising the fluorescent gadolinium complex compound according to claim 7 as an active ingredient.

11. A fluorescent MRI contrast medium comprising the fluorescent gadolinium complex compound according to claim 2 as an active ingredient.

12. A fluorescent MRI contrast medium comprising the fluorescent gadolinium complex compound according to claim 3 as an active ingredient.

13. A fluorescent MRI contrast medium comprising the fluorescent gadolinium complex compound according to claim 7 as an active ingredient.
